(19) United States
(12) Patent Application Publication
(10) Pub. No.: US 2024/0424403 A1
(43) Pub. Date: Dec. 26, 2024

(54) PROGRAM, INFORMATION PROCESSING SYSTEM, AND INFORMATION PROCESSING METHOD

(71) Applicant: CYGAMES, INC., Tokyo (JP)

(72) Inventors: Naoyuki Takahashi, Tokyo (JP); Satoshi Yonekawa, Tokyo (JP); Yuki Nishi, Tokyo (JP); Tetsu Izawa, Tokyo (JP)

(73) Assignee: CYGAMES, INC., Tokyo (JP)

(21) Appl. No.: 18/827,203

(22) Filed: Sep. 6, 2024

Related U.S. Application Data
(63) Continuation of application No. PCT/JP2023/010598, filed on Mar. 17, 2023.

(30) Foreign Application Priority Data
Mar. 25, 2022 (JP) 2022-049910

(51) Int. Cl. A63F 13/58

(52) U.S. Cl. CPC A63F 13/58

(57) ABSTRACT

Provided are a program, an information processing system, and an information processing method for improving convenience regarding information exchange between players. In a game in which, on the basis of factor information linked to a nurtured character possessed by a player, the ability of another character is affected when said another character is nurtured, selection of the nurtured character serving as a post target from the nurtured character possessed by the player is accepted, and a player name card can be generated on the basis of factor information linked to the nurtured character selected as a post target, the player name card consisting of a front-surface image on which the factor information is simply displayed and a rear-surface image on which the factor information is specifically displayed.

### CROSS-REFERENCE TO RELATED APPLICATIONS

This application is a continuation of International Patent Application No. PCT/JP2023/10598, having an international filing date of Mar. 17, 2023, which designated the United States, the entirety of which is incorporated herein by reference. Japanese Patent Application No. 2022-049910 filed on Mar. 25, 2022 is also incorporated herein by reference in its entirety.

### BACKGROUND OF THE INVENTION

The present invention relates to a program, an information processing system, and an information processing method for a game in which, on the basis of specific information linked to a character possessed by a player, the ability of another character is affected in the game progress using said another character.

Conventionally, there exists a function of encouraging friend registration between players, by posting, to SNS (social networking service), a profile image on which profile information such as a player ID of a player has been compiled (see “Guidance to create Deresute name card! Cooperation with Twitter”, [online], May 11, 2018, Deresute guidance summary, [searched on Mar. 18, 2022], Internet<URL: https://deresute-kouryaku.com/card>).

However, when the amount of information disclosed on the profile image is increased, there may arise an inconvenience that it becomes troublesome to browse the profile image and an inconvenience that it is hard to find a player suitable for friend registration.

### SUMMARY OF THE INVENTION

The present invention has been made in view of the above-described circumstances, and an object thereof is to provide a program, an information processing system, and an information processing method for improving convenience regarding information exchange between players.

According to a first aspect of the disclosure, there is provided a program for a game in which, on the basis of specific information linked to a character possessed by a player, the ability of another character is affected in the game progress using said another character, the program causing a computer to function as:
a character selection accepting unit that accepts selection of the character serving as a post target from the character possessed by the player; and
an image generating unit that generates, on the basis of the specific information linked to the character selected as the post target, a first image on which the specific information is simply displayed and a second image on which the specific information is specifically displayed.

According to a second aspect of the disclosure, there is provided an information processing system for a game in which, on the basis of specific information linked to a character possessed by a player, the ability of another character is affected in the game progress using said another character, the information processing system comprising:
a character selection accepting unit that accepts selection of the character serving as a post target from the character possessed by the player; and
an image generating unit that generates, on the basis of the specific information linked to the character selected as the post target, a first image on which the specific information is simply displayed and a second image on which the specific information is specifically displayed.

According to a second aspect of the disclosure, there is provided an information processing method for a game in which, on the basis of specific information linked to a character possessed by a player, the ability of another character is affected in the game progress using said another character, the information processing method comprising:
a character selection accepting step for accepting selection of the character serving as a post target from the character possessed by the player; and
an image generating step for generating, on the basis of the specific information linked to the character selected as the post target, a first image on which the specific information is simply displayed and a second image on which the specific information is specifically displayed.

### BRIEF DESCRIPTION OF DRAWINGS

FIG. 1 is a view showing the overall configuration of an information processing system.

FIG. 2 is a functional block diagram of a server, related to a nurture function of nurturing a character, among functions realized by the information processing system.

FIG. 3 is a functional block diagram of a player terminal, related to the nurture function of nurturing a character, among the functions realized by the information processing system.

FIG. 4 is a flowchart showing an example of processing related to the nurture function of nurturing a character.

FIG. 5 is a view showing an example of a nurture character selection screen displayed at the player terminal.

FIG. 6 is a view showing an example of an inheritance character selection screen displayed at the player terminal.

FIG. 7 is a view showing an example of an inheritance-character list screen displayed at the player terminal.

FIG. 8 is a view showing an example of the inheritance character selection screen displayed at the player terminal.

FIG. 9 is a view showing an example of the inheritance character selection screen displayed at the player terminal.

FIG. 10 is a view showing an example of a support organization screen displayed at the player terminal.

FIG. 11 is a view showing an example of a final confirmation screen displayed at the player terminal.

FIG. 12 is a view showing an example of a nurture home screen displayed at the player terminal.

FIG. 13 is a view showing an example of a training screen displayed at the player terminal.

FIG. 14 is a view showing an example of a race list screen displayed at the player terminal.

FIG. 15 is a view showing an example of the nurture home screen displayed at the player terminal.

FIG. 16 is a view showing an example of the race list screen displayed at the player terminal.

FIG. 17 is a view showing an example of a goal achievement notification screen displayed at the player terminal.

FIG. 18 is a view showing an example of a goal list screen displayed at the player terminal.

FIG. 19 is a view showing an example of a nurture-goal completion screen displayed at the player terminal.

FIG. 20 is a view showing an example of the goal list screen displayed at the player terminal.

FIG. 21 is a view showing an example of a profile screen displayed at the player terminal.

FIG. 22 is a view showing an example of a player name-card screen displayed at the player terminal.

FIG. 23 is a view showing an example of the player name-card screen displayed at the player terminal.

FIG. 24 is a view showing an example of a name-card edit screen displayed at the player terminal.

FIG. 25 is a view showing an example of the name-card edit screen displayed at the player terminal.

FIG. 26 is a view showing an example of the name-card edit screen displayed at the player terminal.

FIG. 27 is a view showing an example of the name-card edit screen displayed at the player terminal.

FIG. 28 is a view for explaining a technique for determining factor information to be displayed on a player name card.

### DETAILED DESCRIPTION OF THE INVENTION

(1) The present embodiment relates to a program for a game in which, on the basis of specific information linked to a character possessed by a player, the ability of another character is affected in the game progress using said another character, the program causing a computer to function as: a character selection accepting unit that accepts selection of the character serving as a post target from the character possessed by the player; and an image generating unit that generates, on the basis of the specific information linked to the character selected as the post target, a first image on which the specific information is simply displayed and a second image on which the specific information is specifically displayed.

(2) In the program according to the present embodiment, according to a display priority order based on the kinds of the specific information linked to the character selected as the post target, the image generating unit may determines the specific information to be displayed on the second image.

(3) In the program according to the present embodiment, the image generating unit generates the first image and the second image such that identification information of the player is displayed on one of the first image and the second image and is not displayed on the other.

(4) The present embodiment relates to an information processing system for a game in which, on the basis of specific information linked to a character possessed by a player, the ability of another character is affected in the game progress using said another character, the information processing system comprising: a character selection accepting unit that accepts selection of the character serving as a post target from the character possessed by the player; and an image generating unit that generates, on the basis of the specific information linked to the character selected as the post target, a first image on which the specific information is simply displayed and a second image on which the specific information is specifically displayed.

(5) The present embodiment relates to an information processing method for a game in which, on the basis of specific information linked to a character possessed by a player, the ability of another character is affected in the game progress using said another character, the information processing method comprising: a character selection accepting step for accepting selection of the character serving as a post target from the character possessed by the player; and an image generating step for generating, on the basis of the specific information linked to the character selected as the post target, a first image on which the specific information is simply displayed and a second image on which the specific information is specifically displayed.

According to the program, the information processing system, and the information processing method of the present embodiment, the first image on which specific information linked to a character that is possessed by the player and that is selected as a post target is simply displayed and the second image on which the specific information is specifically displayed are generated, thereby making it possible to give the player a room for selection of an image of a suitable amount of information for the usage and to improve convenience regarding information exchange between players.

Furthermore, when specific information to be displayed on the second image is determined according to a display priority order based on the kinds of specific information linked to the character selected as the post target, it is possible to encourage useful information exchange between players.

Furthermore, when the first image and the second image are generated such that the identification information of the player is displayed on one of the first image and the second image and is not displayed on the other, it is possible to give consideration to a player who does not desire the personal information to be identified and to encourage active information exchange between players.

An embodiment of the present invention will be described below. Note that this embodiment to be described below does not unduly limit the content of the invention stated in the claims. Furthermore, all constituents described in this embodiment are not necessarily indispensable constituent features of the present invention.

### 1. Configuration of Information Processing System

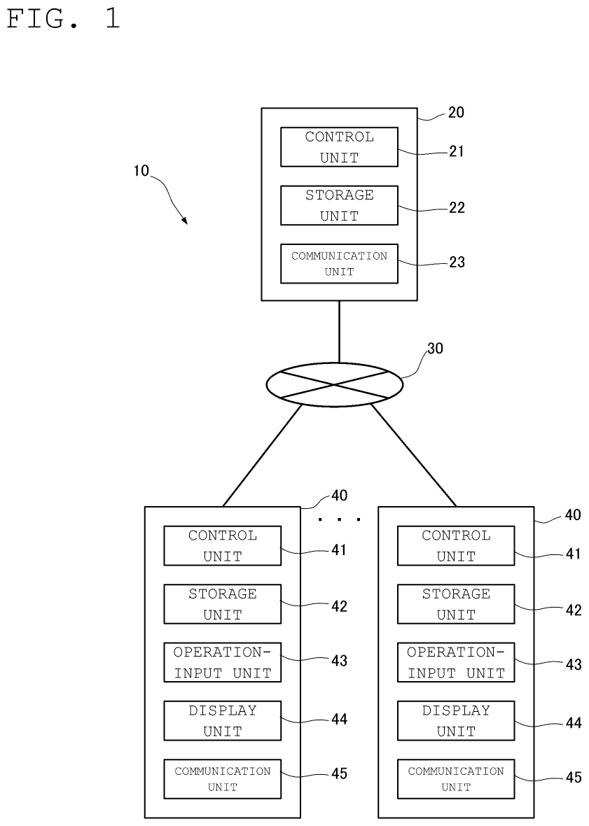

FIG. 1 is a view showing the overall configuration of an information processing system 10 of this embodiment. As shown in FIG. 1, in the information processing system 10, a server 20 and a plurality of player terminals 40 are connected by a network 30, such as the Internet, a mobile phone network, a LAN, and a WAN, whereby a so-called client-server communication system is built. Then, each of the plurality of player terminals 40 and the server 20 communicate with each other via the network 30 to send and receive various kinds of information. Furthermore, the plurality of player terminals 40 communicate with each other via the network 30 and the server 20 to send and receive various kinds of information.

The server 20 includes: a control unit 21 that is configured by a processor such as a CPU; a storage unit 22 that is configured by a main storage device such as a ROM and a RAM and an auxiliary storage device such as an HDD and an SSD; and a communication unit 23 that is configured by a communication module and a communication interface. At the server 20, the control unit 21 executes various kinds of processing according to a program stored in the storage unit 22. Furthermore, the server 20 receives information from the player terminals 40 and sends information etc. related to the results of the processing executed by the control unit 21 to the player terminals 40, by means of the communication unit 23.

The player terminals 40 are smartphones, tablets, personal computers, portable game machines, installed game machines installed at stores and homes, or the like. Each of the player terminals 40 includes: a control unit 41 that is configured by a processor such as a CPU; a storage unit 42 that is configured by a main storage device such as a ROM and a RAM and an auxiliary storage device such as a flash memory, an HDD, and an SSD; an operation-input unit 43 that is configured by a touchscreen, a keyboard, and a microphone; a display unit 44 that is configured by a liquid crystal display or an organic EL display; and a communication unit 45 that is configured by a communication module and a communication interface. The player terminal 40 also executes various kinds of processing according to a program stored in the storage unit 42. Furthermore, the player terminal 40 receives information from the server 20 and sends information to the server 20 and the other player terminal 40, by means of the communication unit 45.

The information processing system 10 of this embodiment has a function of providing, via the player terminals 40, a game in which a character with a motif of a racehorse is nurtured, and the nurtured character is made to participate in a race to compete with other characters. In particular, the information processing system 10 of this embodiment has: a nurture function of nurturing a character; a name-card creation function of creating a player name card on which profile information of a player is posted; a race match function of showing a race match of the nurtured character and other characters; a live viewing function of showing live singing of a character; and a photo function of acquiring, saving, and showing a screenshot image of a game screen. A description will be given below of a case in which these functions are realized mainly by the player terminal 40. However, the above-mentioned functions may be realized mainly by the server 20 or may be realized by the server 20 and the player terminal 40 in a shared manner.

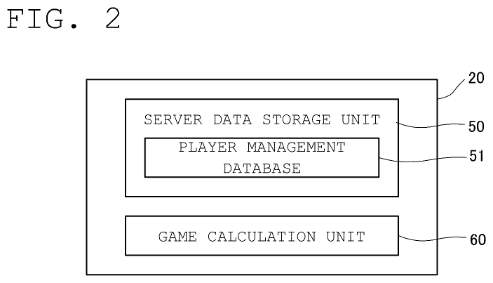

FIG. 2 is a functional block diagram showing main functions of the server 20.

The server 20 in the information processing system 10 has: a function of managing players, characters, etc., by using various kinds of identification information; and a function of performing calculation necessary to proceed with the game in response to a request from the player terminal 20 and sending the calculation result to the player terminal 40. A server data storage unit 50 and a game calculation unit 60 cooperate to realize these functions.

The server data storage unit 50 includes a player management database 51 and is realized mainly by the storage unit 22. In this embodiment, a character list, an item list, a nurture target list, etc., are stored in the player management database 51 while being linked to the player ID given to each player.

The character list includes, for example, a character individual ID given to each nurtured character, a character type ID indicating the type of a character, the statuses of a character (rarity, evaluation points, course aptitudes, distance aptitudes, running-style aptitudes, running way, speed, stamina, power, spirit, wisdom, possessed skills, and an obtained title(s)), a lock state (locked or unlocked), and the nurture history of a character (nurture condition and race results during nurture).

In this embodiment, “nurtured character” means a character that has been nurtured and of which the statuses have been determined at the end of the nurture thereof, by the nurture function, which is one of the game functions realized by the information processing system 10 of this embodiment.

Furthermore, in this embodiment, “character individual ID” and “character type ID” are used, and the difference therebetween is as follows.

First, the “character individual ID” is an ID given when nurture of a character is completed in the nurture function, and the nurtured character is registered to the character management database 51. The “character individual ID” is used to identify each nurtured character linked to the player ID.

Furthermore, this embodiment has a specification in which a player selects a nurture target from among a plurality of types of characters, in the nurture function. The “character type ID” is an ID given to identify the type of a nurtured character.

Furthermore, “lock state” indicates whether transfer of a nurtured character (deletion from the character list) is prohibited or not, transfer is allowed in the case of an unlocked state, and transfer is not allowed in the case of a locked state. Example situations of being in the locked state include: when the player individually specifies the locked state from the list of nurtured characters; and when a nurtured character is registered to participate in a race.

In the nurture target list, data in which information indicating “released” or “not released” is associated with each character type ID is stored. In this embodiment, a character with which information indicating “released” is associated in the nurture target list is a character that can be selected by the player as a nurture target in the nurture function. Furthermore, in this embodiment, it is possible to newly release a character by using a release item or by a character acquisition lottery, and the number of characters that can be selected as a nurture target(s) is different depending on the player. Hereinafter, a character that can be selected as a nurture target in the nurture function is referred to as a released character, in some cases.

The item list includes data related to items, strengthening points, and in-game currency that are possessed by the player. In this embodiment, for example, the content of and the number of possessed items, the amount of possessed strengthening points, and the amount of possessed in-game currency are stored, in the form of the item list, in the player management database 51.

Examples of items in this embodiment are, for example, an item used to support nurture of a character, an item used to change the condition of a race to participate, etc. Those items can be obtained in accordance with the result of a race or by consuming the in-game currency.

Furthermore, the strengthening points are used, for example, to strengthen support items that are items for supporting the nurture of a character. A character can be nurtured in a more advantageous nurture environment as the support items are strengthened.

Furthermore, a friend list is data stored in the player management database 51. In this embodiment, it is possible to register another player as a friend and to borrow and use a character or a support item from the other player registered as a friend, in the nurture function. The friend registration is performed as follows: the player ID of another player is input in a friend registration screen displayed on the display unit 44 of the player terminal 40, and, if the player corresponding to the player ID exists and if friend registration of that player is enabled, a tap input is performed with respect to a registration button provided in the friend registration screen, whereby the player ID of the other player who is a registration-target is added to the friend list. Since an upper limit (for example, 50) on the number of friends that can be registered is provided for each player, and an upper limit (for example, 100) on the number of times to be registered as a friend is also provided for each player, it is possible to perform new friend registration if the corresponding upper limit has not been reached.

The game calculation unit 60 performs calculation necessary to proceed with the game in response to a request from the player terminal 20, performs processing for sending the calculation result to the player terminal 40 and processing for sending data necessary to proceed with the game to the player terminal 40 in response to a request from the player terminal 20. The game calculation unit 60 is realized mainly by the control unit 41 and the communication unit 45. For example, when a request related to a training direction is received from the player terminal 20 in the nurture function, the game calculation unit 60 calculates the result indicating either success or failure of the training and sends the calculation result to the player terminal 40. Furthermore, for example, when a request related to participation in a race is received in the nurture function, the game calculation unit 60 performs running simulation of the race of a plurality of characters including the nurture-target character and non-player characters (NPCs) and sends the result of the running simulation to the player terminal 40.

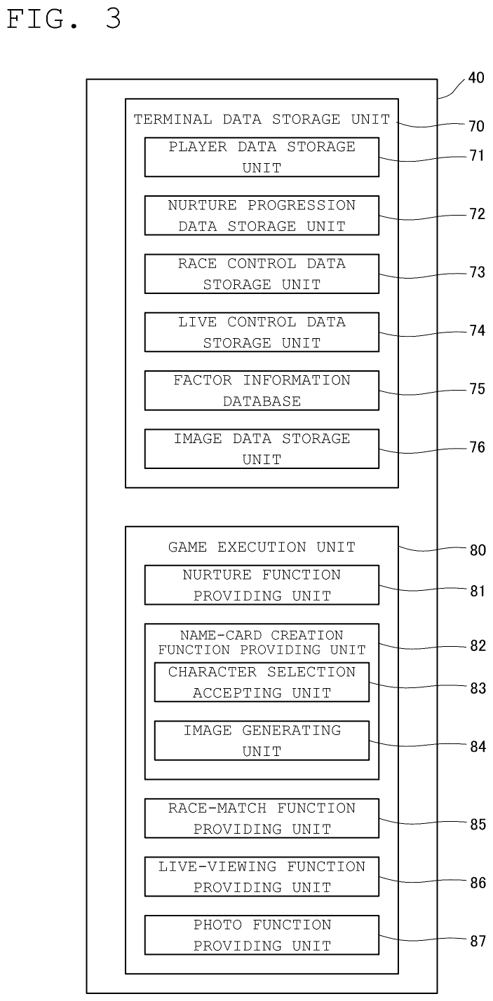

FIG. 3 is a functional block diagram showing main functions of the player terminal 40.

As shown in FIG. 3, the player terminal 40 in the information processing system 10 of this embodiment realizes the nurture function, the name-card creation function, the race match function, the live viewing function, the photo function, etc., through cooperation of a terminal data storage unit 70 and a game execution unit 80.

The terminal data storage unit 70 stores data used when the game execution unit 80 performs various kinds of processing, and is mainly realized by the storage unit 42.

The terminal data storage unit 70 includes a player data storage unit 71, and data, related to the character list, the nurture target list, the item list, and the friend list, associated with the player ID is stored in the player data storage unit 71. In this embodiment, at the start and the end of an application and in the other necessary situations, synchronous processing is performed, between the player data storage unit 71 of the player terminal 40 and the player management database 51 of the server 20, on data (the character list, the nurture target list, the item list, and the friend list) linked to the player ID, and various kinds of game processing are executed by using the data stored in the player data storage unit 71. In this embodiment, in the case where it becomes necessary to change the character list, the nurture target list, the item list, and the friend list along with execution of various kinds of game processing, the storage content of the player data storage unit 71 is updated, and the updated storage content is backed up to the player management database 51 of the server 20, whereby the storage content of the player data storage unit 71 and that of the player management database 51 are synchronized. Note that the data linked to the player ID, such as the character list, the nurture target list, the item list, and the friend list, may also be downloaded from the player management database 51 to the player data storage unit 71, as needed, e.g., at the start of an application.

Furthermore, the terminal data storage unit 70 includes a nurture progression data storage unit 72, and the nurture progression data storage unit 72 stores data (nurture progression data) necessary for progression of the nurture function of a character (a character of the character type ID with which information indicating “released” is associated in the nurture target list) that can be selected as a nurture target in the nurture function. In this embodiment, nurture goals and game events related to the nurture function are prepared for each character, and the nurture progression data including at least the setting content of the nurture goals and the setting content of the game events is stored in the nurture progression data storage unit 72 while being linked to the character type ID.

Furthermore, the terminal data storage unit 70 includes a race control data storage unit 73, and the race control data storage unit 73 stores data for controlling the movement of a character and a production of skill activation when a race in which the character participates is shown in the nurture function and the race match function, and text data and audio data for race commentary, etc.

Furthermore, the terminal data storage unit 70 includes a live control data storage unit 74, and the live control data storage unit 74 stores music data, character's singing data, character's movement data, etc., related to the live viewing function.

Furthermore, the terminal data storage unit 70 includes a factor information database 75, and information about a factor name, a factor level, a factor type, etc., is stored in the factor information database 75 while being linked to a factor registration ID. The factor information is information that is linked to a nurtured character in the case where the character has been nurtured in the nurture function. In this embodiment, when a character is nurtured in the nurture function, a factor inheritance event occurs as a game event for status reinforcement that affects the abilities of the nurture-target character, such as an increase in skill acquisition level and an increase in performance parameter, on the basis of the factor information linked to nurtured characters selected as inheritance characters.

The factor information has four classes, i.e., a blue factor, a red factor, a unique factor, and a white factor. Three factor levels are set for each piece of the factor information, and an effect that is more advantageous to status reinforcement can be obtained as the factor level is higher. Furthermore, the blue factor, the red factor, the unique factor, and the white factor are further classified into factor types. The blue factor is factor information with the name of performance parameters and affects the performance parameters. The amounts of increase in the performance parameters become larger as the factor level thereof is higher. The red factor is factor information with the name of a course aptitude, a distance aptitude, or a running-style aptitude, and affects the course aptitude, the distance aptitude, or the running-style aptitude. The aptitude is likely to be increased in the factor inheritance event as the factor level thereof is higher. The unique factor is factor information with the name of a unique skill and allows the unique skills of the inheritance characters to be obtained. The unique-skill acquisition level is likely to be raised as the factor level thereof is higher. The skill acquisition level affects the consumption amount of skill points when a skill is obtained, and the consumption amount of skill points is reduced as the acquisition level is higher. The white factor is factor information that does not belong to any of the blue factor, the red factor, and the unique factor, and the white factor includes a skill factor, a race factor, and a scenario factor. The skill factor is factor information with the name of a skill, makes the normal skill (skills other than the unique skill) acquisition level likely to be raised, and exists for each skill kind. The race factor is factor information with the name of a race or a race track and makes at least either the normal-skill acquisition level or the performance parameters likely to be raised, and an effect thereof is different depending on the kind of a race or the kind of a race track. The scenario factor is factor information with the name of the nurture scenario, the factor information being related to the nurture scenario in which the character is nurtured. In the case where the scenario factor is inherited in the factor inheritance event, a plurality of performance parameters can be significantly increased, and the performance parameters to be increased are different depending on the kind of the scenario factor. Furthermore, in terms of the above-mentioned factor types, the factor information is classified into six kinds, i.e., the blue factor, the red factor, the unique factor, the skill factor, the race factor, and the scenario factor.

Furthermore, the terminal data storage unit 70 includes an image data storage unit 76, and screenshot images acquired by using the photo function are stored in the image data storage unit 76. In this embodiment, it is possible not only to browse screenshot images stored in the image data storage unit 74 in the photo function but also to use the screenshot images in the name-card creation function.

The game execution unit 80 performs processing for starting a game in the case where a game start condition is satisfied, processing for executing a game mode selected from among a plurality of types of game modes, processing for making the game progress, processing for making an event occur in the case where an event occurrence condition is satisfied, processing for calculating a game result, processing for ending the game in the case where a game end condition is satisfied, processing for requesting the server 20 to perform calculation, processing for obtaining a calculation result and necessary data from the server 20, and processing for sending the calculation result and data of the player terminal 40, to the server 20. The game execution unit 80 is realized mainly by the control unit 41 and the communication unit 45. In this embodiment, the game execution unit 80 includes a nurture function providing unit 81, a name-card creation function providing unit 82, a race-match function providing unit 85, a live-viewing function providing unit 86, and a photo function providing unit 87.

The nurture function providing unit 81 performs processing for providing the nurture function of nurturing a character. In this embodiment, an input related to nurture of a character is accepted, and display of a calculation result with respect to the input is performed.

In this embodiment, when a character is nurtured in the nurture function, it is required to select, in each turn, an action that is a target for turn consumption. Examples of a turn-consumption target action include training, participation in a race, going out, infirmary, etc. The nurture function providing unit 81 accepts selection of a turn-consumption target action via a nurture home screen etc. displayed on the display unit 44 and requests the server 20 to calculate the result with respect to the selected action. At the server 20, upon reception of the request, calculation for the result with respect to the selected action is performed, and the calculation result is sent to the player terminal 40. The nurture function providing unit 81 makes a display screen corresponding to the calculation result received from the server 20, displayed on the display unit 44.

Furthermore, in this embodiment, nurture goals are set according to the type of a nurture-target character, and, in some of the nurture goals, there is a required action that is forcibly selected in a predetermined turn. For example, in some of the nurture goals, the required action is to participate in a predetermined race or to obtain a result of a predetermined order of arrival in a predetermined race. In this case, in a turn in which a predetermined race associated with any of the nurture goals is set, participation in the race is the required action, and it is impossible to select turn-consumption target actions other than participation in the race. In this way, in a turn in which selection of a required action is to be accepted, the nurture function providing unit 81 performs control so as to restrict selection of actions that are different from the required action.

The name-card creation function providing unit 82 performs processing for providing the name-card creation function of creating a name-card image on which the profile information of the player is posted.

In this embodiment, a player name card consisting of a front-surface image and a rear-surface image can be created by using the name-card creation function. Note that, of the front-surface image and the rear-surface image, the rear-surface image is not always created, and the rear-surface image is created in the case where creation of the rear-surface image is permitted in option settings. The name-card creation function providing unit 82 includes a character selection accepting unit 83 and an image generating unit 84.

The character selection accepting unit 83 performs processing for accepting selection of a nurtured character that is to become a post target for a name-card image, from among nurtured characters possessed by the player. In this embodiment, it is possible to set a representative character, from among the nurtured characters possessed by the player, via the profile screen displayed on the display unit 44, and the representative character is a post target for the name-card image. The character selection accepting unit 83 accepts selection of the representative character via a name-card edit screen displayed on the display unit 44 and allows a change in the representative character. That is, a representative character that is set via the profile screen becomes a post target in the initial settings in the name-card edit screen, and, in the case where the representative character is changed via the name-card edit screen, the content of the change in the representative character is reflected also in the profile screen.

The image generating unit 84 performs processing for generating, on the basis of factor information linked to the nurtured character selected as a post target, a front-surface image on which the factor information is simply displayed and a rear-surface image on which the factor information is specifically displayed. In this embodiment, the factor information on the red factor, the blue factor, and the unique factor of the representative character is displayed on the front-surface image, and the factor information on the red factors, the blue factors, the unique factors, and the white factors of the representative character and the two inheritance characters is displayed on the rear-surface image.

Furthermore, the image generating unit 84 performs processing for determining factor information to be displayed on the rear-surface image, according to a display priority order based on the kinds of the factor information linked to the nurtured character selected as a post target. In this embodiment, as a whole, the display priority order has five stages and is set in the order of the red factor>the blue factor>the unique factor>the white factor (the scenario factor)>the white factor (factors other than the scenario factor). Furthermore, for the white factor (the race-track factor and the skill factor) other than the scenario factor, the display priority order has two stages and is set in the order of the factor level>the factor registration ID. Then, for the rear-surface image, an upper limit is set on the number of pieces of factor information that can be displayed for one character, and, in the case where the number of pieces of factor information that exceeds the upper limit is linked, display-target factor information for the rear-surface image is determined from the top of the display priority order so as not to exceed the upper limit.

Furthermore, the image generating unit 84 performs processing for generating the front-surface image and the rear-surface image so as to display the player ID on the front-surface image and so as not to display the player ID on the rear-surface image. Note that it is also possible not to display the player ID on the front-surface image and to display the player ID on the rear-surface image. That is, the image generating unit 84 can generate the front-surface image and the rear-surface image so as to display the player ID on one of the front-surface image and the rear-surface image and so as not to display the player ID on the other. However, it is also possible to display the player ID on both of the front-surface image and the rear-surface image.

The race-match function providing unit 85 performs processing for providing the race match function of making some of the nurtured characters possessed by the player play against nurtured characters of other players or non-player characters (NPCs), in a race.

In this embodiment, in the case where the player is an organizer of a race, it is possible to set the number of participation registrations within the range from nine to eighteen characters, to register at most three nurtured characters for participation, and to make the remaining participation slots filled up with nurtured characters of other players and/or non-player characters (NPCs), thus performing a race match of those characters registered for participation. Furthermore, in the case where there are empty slots in the number of participation registrations with respect to a race organized by another player, it is possible to register at most three nurtured characters for participation, and a race match of characters that are registered for participation can be performed, as in the case of a race organized by the player him/herself.

In the case where the organizer of a race permits participation at the player terminal 40, a race running simulation is executed at the server 20, and the race-match function providing unit 85 allows a request for the result of the running simulation to be made from the player terminal 40 to the server 20. At the player terminal 40, upon reception of the result of the running simulation from the server 20, the race-match function providing unit 85 generates a race video based on the result of the running simulation on the basis of various kinds of data stored in the race control data storage unit 73, and makes the generated race video displayed on the display unit 44, whereby the player can view the race.

The live-viewing function providing unit 86 performs processing for providing a live viewing function of showing live singing of a character that can be selected as a nurture target in the nurture function by the player and/or a non-player character (NPC).

In this embodiment, in the live viewing function, the player can select a character(s) that is to participate in a live and view live singing of the member(s) selected by the player. Songs in the live singing can be selected from among a plurality of kinds of songs, and the live-viewing function providing unit 86 generates a live video on the basis of data corresponding to the selected songs stored in the live control data storage unit 74 and makes the generated live video displayed on the display unit 44, whereby the player can view the live singing.

The photo function providing unit 87 performs processing for providing the photo function of acquiring, saving, and browsing a screenshot image of the game screen.

In this embodiment, acquisition of a screenshot image using the photo function can be performed while a race video is being viewed in the race match function and while a live video is being viewed in the live viewing function. In the photo function, ON and OFF can be switched in the setting for an input interface, and, in the case where the photo function is set to ON, an image acquisition button is disposed on the display screen for the race video or the live video. When the player taps the image acquisition button at an arbitrary timing, the race video or the live video is paused, and a screenshot image is acquired. Then, when the player performs an input for determining saving of the acquired screenshot image, the acquired screenshot image is saved in the image data storage unit 76. Furthermore, in the photo function, it is possible to display a list of screenshot images and to browse an arbitrary screenshot image(s). Furthermore, a screenshot image stored in the image data storage unit 76 can be used to create a player name card by means of the name-card creation function.

2. Control Technique of this Embodiment

A control technique of this embodiment will be described below by using an example case in which a game program of this embodiment is applied to a game application in the player terminal 40, which is provided as a smartphone.

The game program of this embodiment is configured so as to be able to provide a plurality of kinds of game functions. In the nurture function, which is a main game function, a nurture-target character is selected from among a plurality of kinds of characters, the statuses of the character change in accordance with the progression of the game, and, when a predetermined end condition is satisfied, the statuses of the character are determined, and the nurture thereof ends. This nurtured character can be made to participate in a race match with characters nurtured by other players, in the race match function, which is another game function. Furthermore, in this embodiment, a possession quota of nurtured characters (the number of nurtured characters that can be registered in the character list) is set in advance, and, when the upper limit (for example, 240 characters) of the possession quota of nurtured characters is reached, it becomes impossible to nurture a new character in the nurture function. Thus, it is necessary to delete a nurtured character from the character list to secure the possession quota.

The information processing system 10, to which the game program of this embodiment is applied, has a specification in which it is possible to rent a nurtured character or a support item of a player who has been registered as a friend and to use it for the nurture of a character in the nurture function. Then, the name-card creation function is provided in order to encourage players to do friend registration, and the players can exchange information by posting, on SNS (social networking service), name-card images created by using the name-card creation function.

Before the name-card creation function is described, the nurture function of nurturing a character will be described here.

In the nurture function, from among a plurality of kinds of characters, one character serving as a nurture target is arbitrarily selected by the player and is nurtured. The initial statuses are set for each of the plurality of kinds of characters that can be selected as a nurture target. Furthermore, a character serving as a nurture target obtains a skill (unique skill) unique to the kind of the character from the beginning of nurture, and an activation condition for the unique skill and an effect to be exerted when the unique skill is activated are different depending on the kind of the character. Furthermore, growth correction rates for parameters of speed, stamina, power, spirit, and wisdom are set for each of the plurality of kinds of characters that can be selected as a nurture target, and the parameter(s) that is likely to be increased is set for each kind of a character.

When a nurture target is selected, and nurture of the character is started, the character can be nurtured by giving a direction of the nurture in each turn of up to 75 turns. Specifically, when a direction of training associated with each of the performance parameters of speed, stamina, power, spirit, and wisdom is given, a change(s) in the corresponding performance parameter(s) and acquisition of skill points occur depending on the training result. Furthermore, participation in a race is directed, thereby making it possible to consume one turn and to cause a change(s) in the corresponding performance parameter(s) and acquisition of skill points depending on the race result. Furthermore, when an event occurrence condition is satisfied during the nurture, an event occurs, thereby causing an increase in the kind of a skill that can be obtained and a change(s) in the corresponding performance parameter(s). The above-described skill points are points to be used to make the nurture-target character obtain a skill, and the possessed skill points can be consumed to obtain a skill from a list of obtainable skills.

Furthermore, in the nurture of a character, a plurality of nurture goals are set for each character depending on the kind of the nurture-target character. Examples of the nurture goals are: to participate in a goal race; to acquire a result of a predetermined order of arrival or higher in a goal race; and to acquire a predetermined number of fans before a set turn. In this embodiment, when the character that is being nurtured is made to participate in a race, the number of fans corresponding to the order of arrival can be obtained, and a participation condition based on the number of fans is set for each race.

Furthermore, in this embodiment, the plurality of nurture goals, which are set for each character, are set in turns up to the 72nd turn, and last races are set in turns from the 73rd turn to the 75th turn. In the last races, a qualifying race, a semi-final race, and a final race are performed in the three turns, and a direction about the nurture can be given before participation in each of the races.

Furthermore, in this embodiment, in the nurture of a character, a continue function is provided as a relief function used when, in the case where a nurture goal of obtaining a result of a predetermined order of arrival or higher in a goal race is set, the result of the specified order of arrival or higher cannot be obtained. The continue function is used to give an opportunity to try again the goal race, and the player consumes the number of continues given in advance, thereby making it possible to try again the goal race. In this embodiment, the number of continues is three over the nurture of one character.

Then, in the nurture game function, when any of a plurality of kinds of end conditions set in advance is established, a transition is made to a nurture-end confirmation state.

First, in the case where the final race of the last races has been reached, i.e., in the case where the 75th turn has been reached, the nurture ends when the final race ends. Note that, in the case where the result is the 2nd place or lower in the final race, it is possible to try again the final race if the number of continues is left; and, in the case where the result is the 2nd place or lower in the final race after the number of continues is all consumed, the nurture ends at this point. Note that it is up to the player whether to use the continue function or not, and, in the case where the player selects not to use the continue function, the nurture ends at this point.

Furthermore, in the case where the nurture goals, which are set for each character in turns up to the 72nd turn, are not achieved, the nurture ends.

For example, in the case where one of the nurture goals is to obtain a predetermined number of fans, if the set number of fans has not been reached in the turn set in the nurture goal, the nurture ends. Since the continue function cannot be used in this case, if the number of fans has not reached the predetermined number of fans when the determination-target turn arrives, the nurture ends.

Furthermore, for example, in the case where one of the nurture goals is to participate in a goal race, when it is possible to participate in the goal race, the nurture goal is achieved irrespective of the order of arrival in the race. However, it is required to obtain the number of fans set as a participation condition for each of the races, and, in the case where the number of fans set as a participation condition for the goal race has not been obtained in the turn of that race, it is impossible to participate in the goal race, and the nurture ends.

Furthermore, for example, in the case where one of the nurture goals is to obtain a predetermined order of arrival or higher in a goal race, if the participation condition for the goal race is not satisfied, the nurture ends at this point, and, even when it is possible to participate in the goal race, if the predetermined order of arrival or higher cannot be obtained and if the number of continues is not left, the nurture ends. Note that the use of the continue function can be arbitrarily selected by the player, as described above, and, in the case where not using the continue function is selected even when the number of continues is left, the nurture goal is not achieved, and the nurture ends.

Furthermore, in the case where the game has advanced to the 73rd or later turn, it is possible to go on to the next turn if the 1st place is obtained in each of the qualifying race and the semi-final race of the last races. If the result is the 2nd place or lower and if the number of continues is not left, the nurture ends. In this case, when the player selects not to use the continue function, the nurture ends at this point.

Then, in this embodiment, when a nurture end condition is established, a transition is made to the nurture-end confirmation state. In this nurture-end confirmation state, a final opportunity to obtain a skill is given before the statuses are determined, and it is possible to obtain a skill by consuming the skill points currently possessed by the player. Furthermore, an input interface for performing a nurture-end confirmation input is prepared in the nurture-end confirmation state, and, when the player performs a nurture-end confirmation input, the statuses of the nurture-target character are determined, and information on the character is registered, as that on a nurtured character, to the character list in the player data storage unit 71 and the character list in the player management database 51.

When the statuses of the nurture-target character are determined through the nurture-end confirmation state, rewards corresponding to the nurture result are provided. In this embodiment, the in-game currency and the strengthening points corresponding to the total number of fans that has been obtained before the nurture ends are provided as rewards.

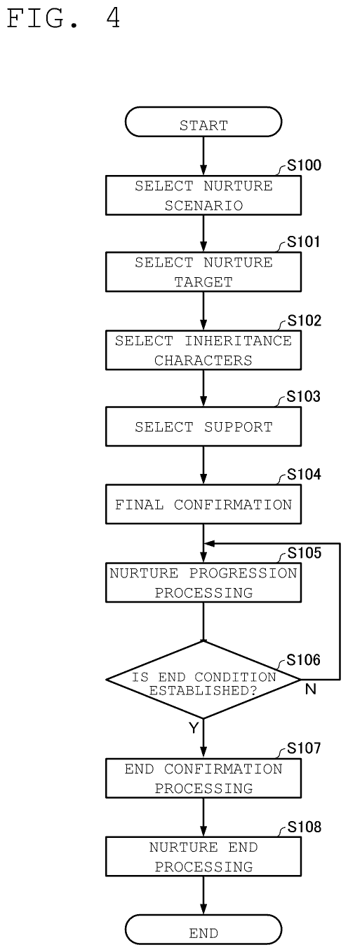

Progression of the game in the nurture function of nurturing a character will be described below in more detail with reference to FIG. 4.

First, prior to the start of nurture of a character, selection of a nurture scenario is accepted (Step S100). In this embodiment, a plurality of kinds of nurture scenarios are prepared, and the way to increase the performance parameters and the way to obtain a skill(s) are different depending on the selected nurture scenario. Targets to be selected as a nurture scenario can be switched with a swipe input, and, after an input for determining a nurture scenario (for example, a tap input with respect to a determination button) is performed, selection of a character to be nurtured in the selected nurture scenario is accepted (Step S101).

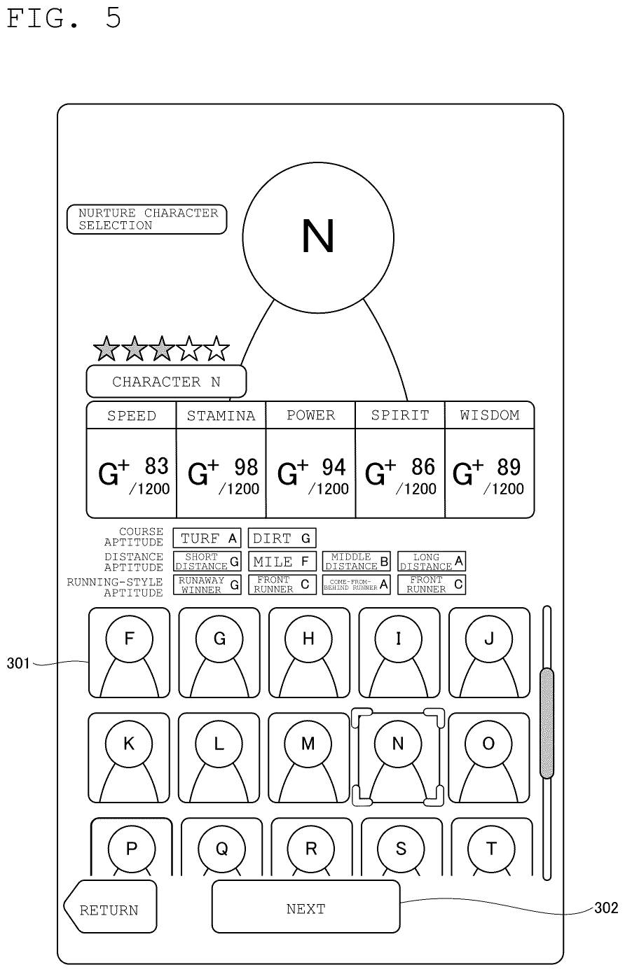

In this embodiment, as shown in FIG. 5, a character icon 301 for identifying each character is tapped in a nurture character selection screen, thereby making it possible to select the nurture target. Information on a character that is selectable as a nurture target (character that can be nurtured) is managed in the nurture target list in the player data storage unit 71, the character type ID of a character that can be nurtured is obtained from the nurture target list, and the nurture character selection screen is displayed. In the nurture character selection screen, information on the initial statuses of the selected character can be confirmed. In this embodiment, as the initial statuses, information on the performance parameters (speed, stamina, power, spirit, wisdom), the course aptitudes (turf, dirt), and the distance aptitudes (short distance, mile, middle distance, long distance), and the running-style aptitudes (runaway winner, front runner, come-from-behind runner, stretch runner) can be confirmed in the nurture character selection screen.

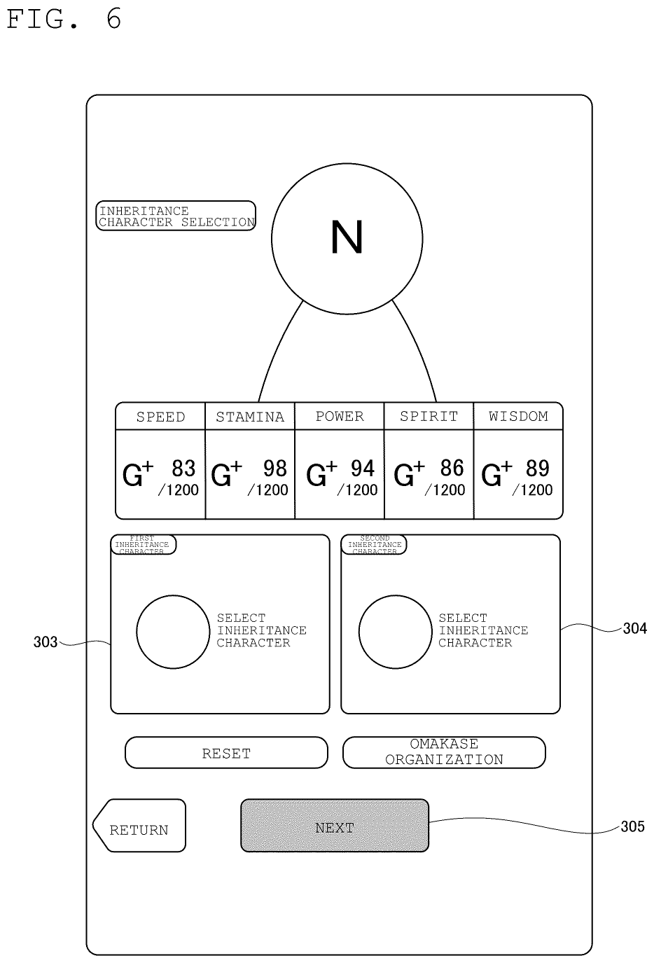

In the nurture character selection screen shown in FIG. 5, when a tap input with respect to a progress button 302 is performed with the character icon 301 of a nurture-target character being selected, the display screen is transitioned to an inheritance character selection screen, as shown in FIG. 6, and selection of inheritance characters is accepted (Step S102).

This embodiment has a specification in which two nurtured characters that have been nurtured by the player in the past are selected as inheritance characters used when new nurture is performed and in which the statuses of the character to be nurtured can be reinforced on the basis of the factor information linked to the selected two inheritance characters (information obtained by the inheritance characters when the inheritance characters were nurtured).

In this embodiment, reinforcement of the statuses of the nurture-target character based on the factor information is performed at the start of the nurture and in the factor inheritance event, which occurs in a predetermined turn after the start of the nurture. In the nurture function, in the case where the factor inheritance event occurs during the nurture of the character, the player terminal 40 sends an event result request to the server 20, and, upon reception of the event result request, the server 20 executes a factor inheritance lottery on the basis of the factor information linked to the two inheritance characters and sends the lottery result to the player terminal 40. Upon reception of the lottery result, the player terminal 40 performs reinforcement of the statuses of the nurture-target character, such as an increase(s) in the performance parameter(s) and an increase in the skill acquisition level, on the basis of the lottery result and executes display processing for notifying the player [of?] the result of the reinforcement of the statuses due to the factor inheritance event.

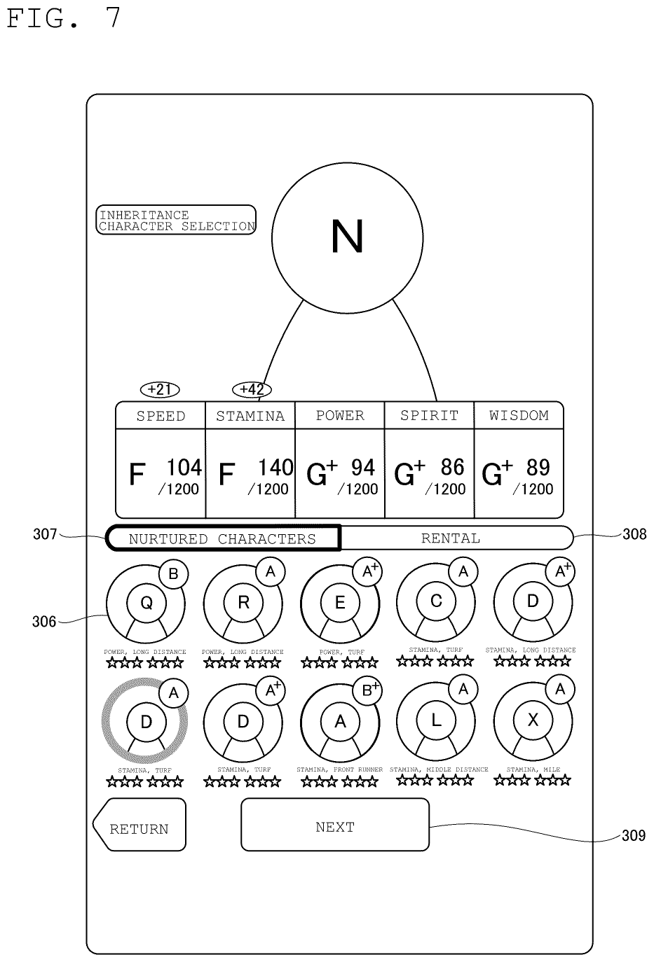

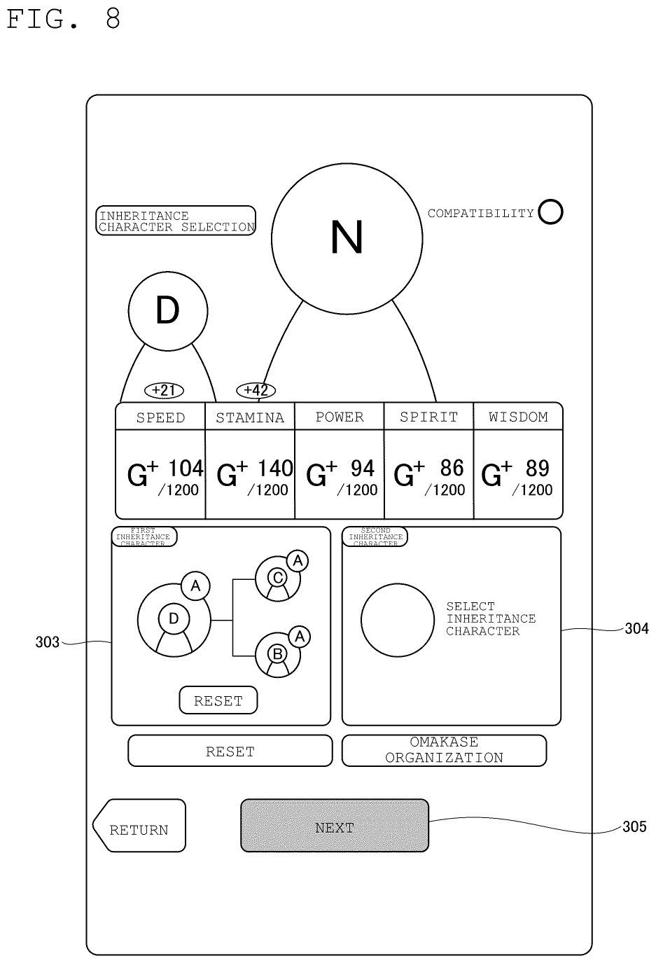

When the inheritance characters are to be selected, a tap input is performed with respect to any of an inheritance frame 303 and an inheritance frame 304 that are provided for the two inheritance characters, thereby displaying a list of selectable inheritance characters. In the inheritance character selection screen shown in FIG. 6, when a tap input is performed with respect to the inheritance frame 303 (or the inheritance frame 304), an inheritance-character list screen is generated by referring to the character list in the player data storage unit 71 and by referring to the list of nurtured characters (inheritance-character list) and is displayed, as shown in FIG. 7. In the inheritance-character list screen, a character can be selected by performing a tap input with respect to a character icon 306, and, when a tap input is performed with respect to a progress button 309 with any inheritance character being selected, the screen returns to the inheritance character selection screen, as shown in FIG. 8.

Furthermore, as the inheritance characters, it is possible not only to use a nurtured character nurtured by the player him/herself but also to rent and use a nurtured character nurtured by another character who has been registered as a friend by the player. In this embodiment, a nurtured character nurtured by another character can be rent up to three times per day. In the inheritance-character list screen shown in FIG. 7, a nurtured-character tab 307 and a rental tab 308 are provided. When a tap input is performed with respect to the rental tab 308, a rental-character acquisition request is sent to the server 20. Upon reception of the rental-character acquisition request, the server 20 refers to the friend registration information (the profile information of another player registered as a friend) linked to the player ID of the transmission source of the rental-character acquisition request and sends, to the player terminal 40, a list of rental characters (rental-character list) set in the profile information by the other player registered as a friend. Then, the player terminal 40 generates and displays the inheritance-character list screen on the basis of the received rental-character list.

Furthermore, it is always necessary to select two inheritance characters in order to start the nurture of a character, and, in a situation in which only one inheritance character has been selected as shown in FIG. 8, a progress button 305 is grayed out, thus making it impossible to progress preparation for the start of the nurture of the character.

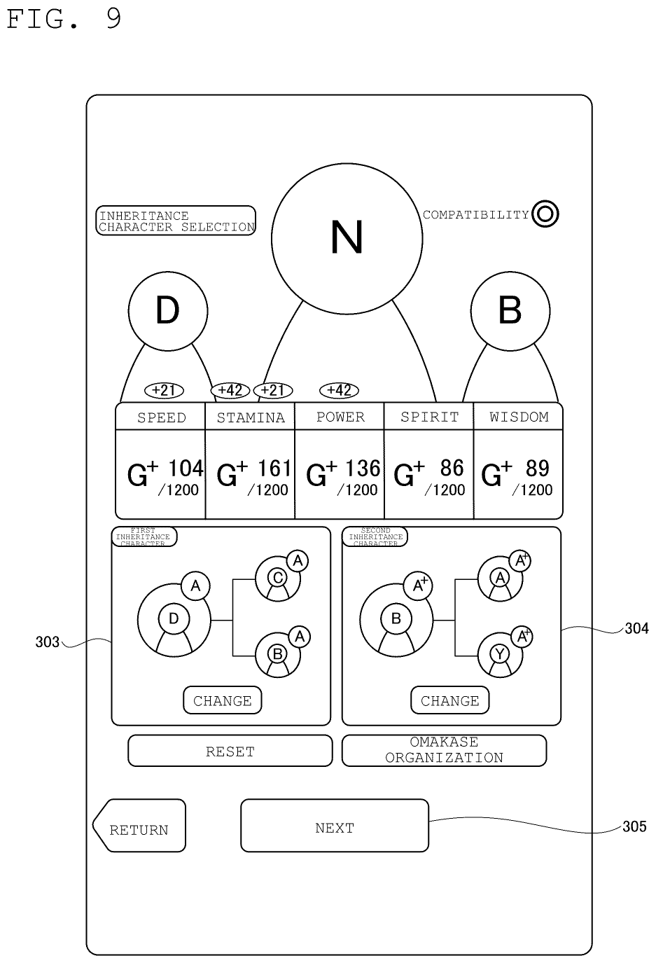

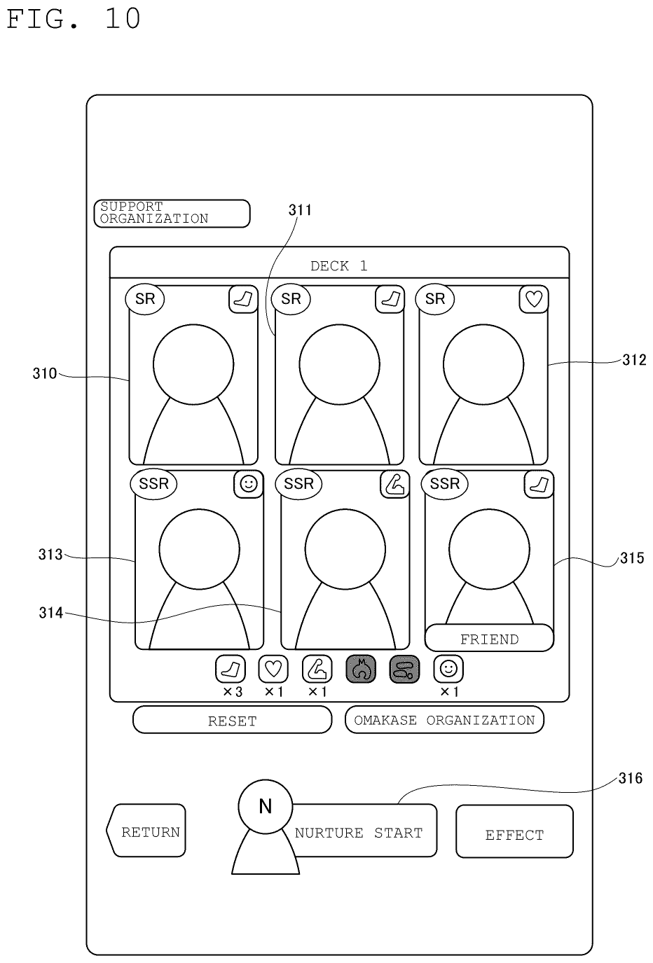

When a tap input is performed with respect to the progress button 305 with two inheritance characters being selected in the inheritance character selection screen, as shown in FIG. 9, the display screen is transitioned to a support organization screen, as shown in FIG. 10, and selection of support items is accepted (Step S103).

In this embodiment, support items shaped like cards are provided as items for supporting the nurture of a character, and, with support items, it is possible to obtain a performance-parameter increase effect and to increase the number of kinds of obtainable skills. When a character is nurtured, it is necessary to organize six support items. Note that a specification is set in which, among the six support items, five support items are selected from the support items possessed by the player him/herself, and the remaining one support item is rent from support items possessed by another player, as a friend quota.

Support items are classified into six classes, i.e., speed, stamina, power, spirit, wisdom, and friend, according to the performance thereof. Support items of speed, stamina, power, spirit, and wisdom literally correspond to the performance parameters of the character and exert parameter increase effects at the time of training, and a support item of friend exerts an effect of restoring the physical strength or the motivation. The classes of support items can be identified by class icons, and the player selects six support items to be used for the current nurture, depending on the class icons. Furthermore, three stages of rarity, i.e., rare (R), super rare (SR), and special super rare (SSR), are provided for each support item. In this embodiment, the rarity becomes higher in the order of R<SR<SSR, and, basically, the support effect of a support item becomes higher as the rarity thereof is higher.

As shown in FIG. 10, five player support frames 310 to 314 and one friend support frame 315 are provided in the support organization screen. When a tap input is performed with respect to any of the player support frames 310 to 314, a list of support items (player support list) is obtained by referring to the item list in the player data storage unit 71. Then, a screen for displaying the list of support items possessed by the player is generated on the basis of the obtained player support list, to accept selection of support items. Furthermore, when a tap input is performed with respect to the friend support frame 315, a friend-support acquisition request is sent to the server 20. Upon reception of the friend-support acquisition request, the server 20 refers to friend registration information linked to the player ID of the transmission source of the friend-support acquisition request and sends, to the player terminal 40, a list of support items (friend support list) set in the profile information by another player registered as a friend. At the player terminal 40, a screen for displaying the list of support items that can be set in the friend support frame 315 is generated on the basis of the received friend support list, to accept selection of a support item.

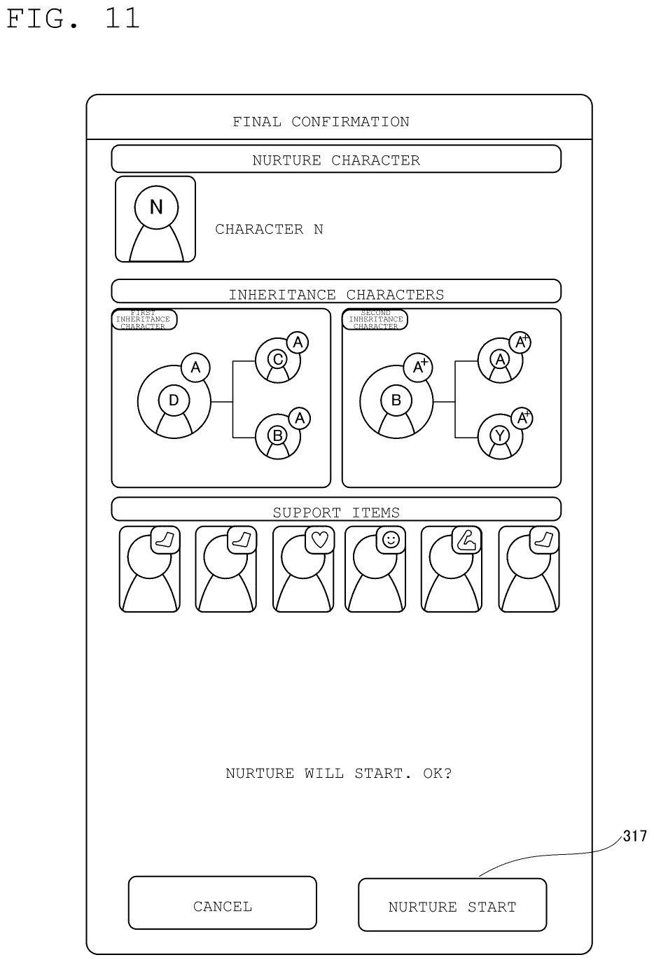

As shown in FIG. 10, when a tap input is performed with respect to a nurture start button 316 with the six support items being organized in the support organization screen, the display screen is transitioned to a final confirmation screen, as shown in FIG. 11, to accept a player's nurture-start confirmation input (Step S104). In the final confirmation screen, the content of organization of the nurture-target character, the inheritance characters, and the support items, which are selected by the player, is displayed.

Then, when a tap input is performed with respect to a nurture-start button 317 in the final confirmation screen, nurture progression processing for nurturing the character is performed (Step S105). Note that, in this embodiment, when a tap input is performed with respect to the nurture-start button 317 in the final confirmation screen at a nurture-start preparatory stage, the nurture-target character is set as a default character. With this setting of the default character, the default character is set as an initial selection character in a nurture-target selection screen when the next nurture is performed, whereby the convenience of a player who repeatedly nurtures the same character is high.

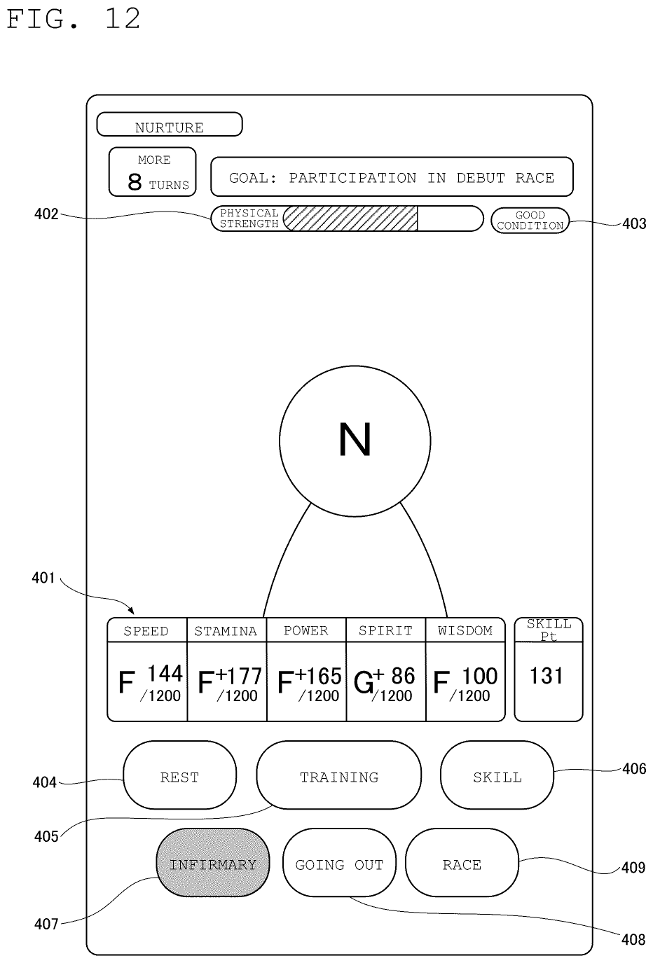

FIG. 12 shows an example of a nurture home screen that is one of the display screens during the nurture of a character.

In the nurture function of a character of this embodiment, transitions are basically made from the nurture home screen to screens for giving directions of various kinds of actions such as training. In the nurture home screen, the nurture-target character is displayed by an animation, and a status display field 401 for displaying the current statuses (speed, stamina, power, spirit, wisdom, and skill points) of the character is provided.

Furthermore, a physical-strength gauge 402 and a motivation icon 403 are displayed in the nurture home screen. The physical-strength gauge 402 is a gauge indicating the physical strength, which is a parameter affecting the failure rate of training. The physical strength changes due to training and participation in races during the nurture, game events occurring during the nurture, etc., and, when the physical strength is reduced, it becomes easy to fail in training, and the motivation is reduced. Furthermore, the motivation icon 403 indicates motivation that is a parameter of the enthusiasm of the character being nurtured, and, in this embodiment, five stages of very bad condition, bad condition, normal condition, good condition, and very good condition are set therefor. This parameter of motivation affects the training effect and the performance parameters at the time of participation in a race. In the case of a very bad condition or a bad condition, the training effect and the performance parameters at the time of participation in a race are corrected downward compared with the case of a normal condition. In the case of a good condition or a very good condition, the training effect and the performance parameters at the time of participation in a race are corrected upward compared with the case of a normal condition.

Furthermore, in the nurture home screen, a rest button 404, a training button 405, a skill button 406, an infirmary button 407, a going-out button 408, and a race button 409 are provided as buttons for selecting various kinds of actions, such as training. In this embodiment, as a general rule, a direction related to one kind of action (specifically, any one kind among rest, training, infirmary, going out, and race) can be given in one turn. When processing for the action corresponding to the direction given in the current turn is completed, the current turn is consumed, and the game progresses to the next turn. Note that, in this embodiment, acquisition of a skill does not involve consumption of a turn as an exception. In this embodiment, in the nurture function, five kinds of actions, i.e., rest, training, infirmary, going out, and race, are set as actions for consuming one turn, as described above, and these actions are referred to as turn consuming actions as needed, in some cases.

The rest button 404 is a button for giving a direction of rest for restoring the physical strength. When a tap input is performed with respect to the rest button 404, a rest confirmation dialog box for confirming that rest is to be directed is displayed. Then, when a tap input is performed with respect to a determination button in the rest confirmation dialog box, a rest result request is sent to the server 20. Upon reception of the rest result request, the server 20 performs calculation related to the amount of restoration of the physical strength, the occurrence or not of a game event, etc., and sends a rest result response including the calculation result to the player terminal 40. Upon reception of the rest result response, the player terminal 40 displays an animation for restoring the physical-strength gauge 402 on the basis of the calculation result included in the rest result response, and executes processing related to a game event in the case where the game event occurs.

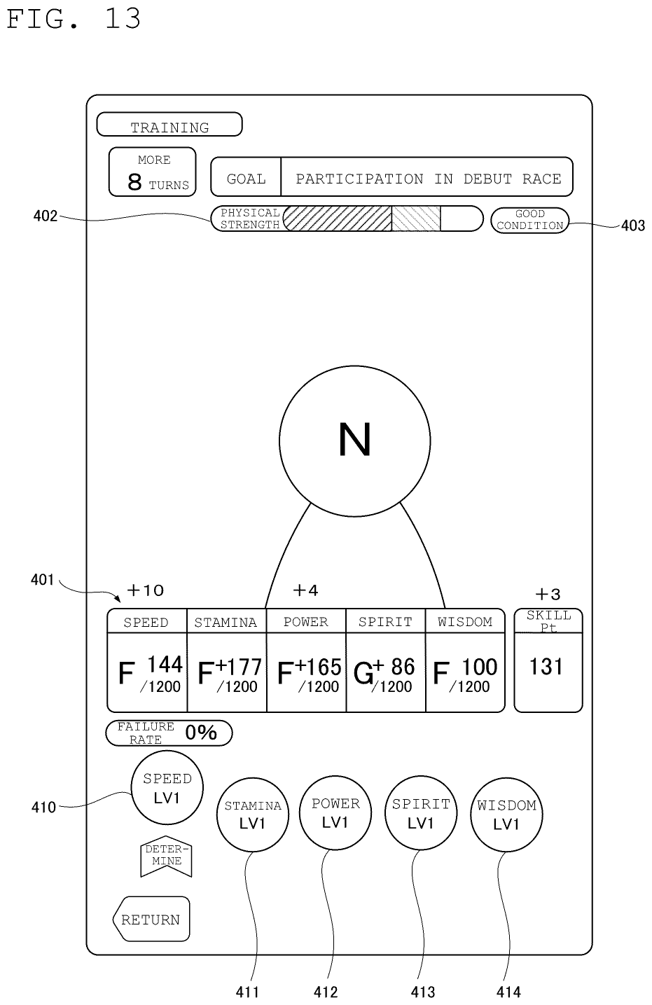

The training button 405 is a button for giving a direction of training for changing the performance parameters of the character. When a tap input is performed with respect to the training button 405, the display screen is transitioned to a training screen, as shown in FIG. 13.

In the training screen, a speed button 410, a stamina button 411, a power button 412, a spirit button 413, and a wisdom button 414 are disposed in an area where the various kinds of buttons were disposed in the nurture home screen. In this embodiment, for explanatory convenience, buttons for giving directions of training are collectively referred to as training buttons, in some cases.

In the training screen, a specification is set in which a direction of training is given by performing a tap input with respect to the training button that is being selected, and the training button that is being selected can be changed by performing a tap input with respect to a training button different from the training button that is being selected.

In the training screen, due to a training direction with the training button that is being selected, how much the corresponding ones of the performance parameters are to be increased and how much the skill points are to be obtained are displayed. In the example shown in FIG. 13, it is indicated that the speed button 410 is being selected, and, in the case where speed training is directed, the parameter of speed can be increased by 10, the parameter of power can be increased by 4, and 3 skill points can be obtained. In this embodiment, in the case where speed training is performed, the parameters of speed and power are increased; in the case where stamina training is performed, the parameters of stamina and spirit are increased; in the case where power training is performed, the parameters of power and stamina are increased; in the case where spirit training is performed, the parameters of spirit, power, and speed are increased; and in the case where wisdom training is performed, the parameters of wisdom and speed are increased. In the case where any training is performed, the skill points can be obtained.

In this embodiment, the support items organized before the start of the nurture are each randomly made to correspond to training by a lottery executed at the server 20 in each turn. The amounts of increase of the performance parameters and the amount of acquisition of the skill points when a training item to which any of the support items is made to correspond is performed become larger due to the effect of the support item.

In the case where training is performed, the physical strength is consumed. The consumption amount of the physical strength due to the training can be grasped in advance at the physical-strength gauge 402 in the training screen. The physical strength is a parameter that affects the failure rate in training, and the failure rate tends to be increased when the physical strength is reduced. In this embodiment, in the case where a training direction is given, the server 20 performs a lottery based on the failure rate and determines whether the training has failed or not. In the case where the training did not fail (in the case where the training has succeeded), the performance parameters corresponding to the training direction are increased. In the case where the training has failed, the physical strength is consumed, without the corresponding performance parameters being increased.

In the training screen, when a tap input is performed with respect to the training button that is being selected, a training result request is sent to the server 20. Upon reception of the training result request, the server 20 performs calculation related to the result of the training, the occurrence or not of a game event, etc., and sends a training result response including the calculation result to the player terminal 40. Upon reception of the training result response, the player terminal 40 performs display processing related to the training result (display related to success/failure of the training and display for changing the corresponding performance parameters) on the basis of the calculation result included in the training result response, and performs processing related to a game event in the case where the game event occurs.

The skill button 406 is a button for making the character obtain a skill. When a tap input is performed with respect to the skill button 406, a skill acquisition screen showing a list of skills that can be obtained by the character at this point is displayed. When a skill is selected and a tap input is performed with respect to an acquisition button in the skill acquisition screen, a skill acquisition request is sent to the server 20. Upon reception of the skill acquisition request, the server 20 registers the skill specified in the skill acquisition request, as an obtained skill in the status information of the character that is being nurtured, and sends a skill acquisition completion response to the player terminal 40. Upon reception of the skill acquisition completion response, the player terminal 40 displays the completion of acquisition of the skill and executes processing for displaying the skill that has been obtained, as an obtained skill in the skill acquisition screen.

The infirmary button 407 is a button used to relieve a bad status given to the character that is being nurtured. Only when a bad status is given due to a game event during the nurture, an input to the infirmary button 407 is accepted. In this embodiment, there is a case in which a bad status such as lack of sleep is given due to the occurrence of a game event, and, when such a bad status is given, a game event that is disadvantageous to the nurture tends to occur, e.g., the physical strength tends to be reduced, or the motivation tends to be reduced. The infirmary button 407 is grayed out in the case where a bad status is not given to the character that is being nurtured, and the infirmary button 407 is normally displayed in the case where a bad status is given to the character that is being nurtured, and a tap input thereto is accepted. In the case where a direction of relief of the bad status is given by means of the infirmary button 407, an infirmary result request is sent to the server 20. Upon reception of the infirmary result request, the server 20 performs a lottery to determine whether the bad status has been relieved and sends an infirmary result response including the determination content to the player terminal 40. Upon reception of the infirmary result response, the player terminal 40 notifies that the bad status has been relieved in the case where the bad status has been relieved, and performs processing for deleting the bad status from the display of the statuses of the character.

The going-out button 408 is a button used to increase the motivation of the character that is being nurtured. When a tap input is performed with respect to the going-out button 408, a going-out confirmation dialog box for confirming that going out is to be directed is displayed. Then, when a tap input is performed with respect to a determination button in the going-out confirmation dialog box, a going-out result request is sent to the server 20. Upon reception of the going-out result request, the server 20 performs a lottery related to a motivation increase event and sends a going-out result response including information of the motivation increase event determined by the lottery to the player terminal 40. Upon reception of the going-out result response, the player terminal 40 executes processing related to the motivation increase event on the basis of the information included in the going-out result response.

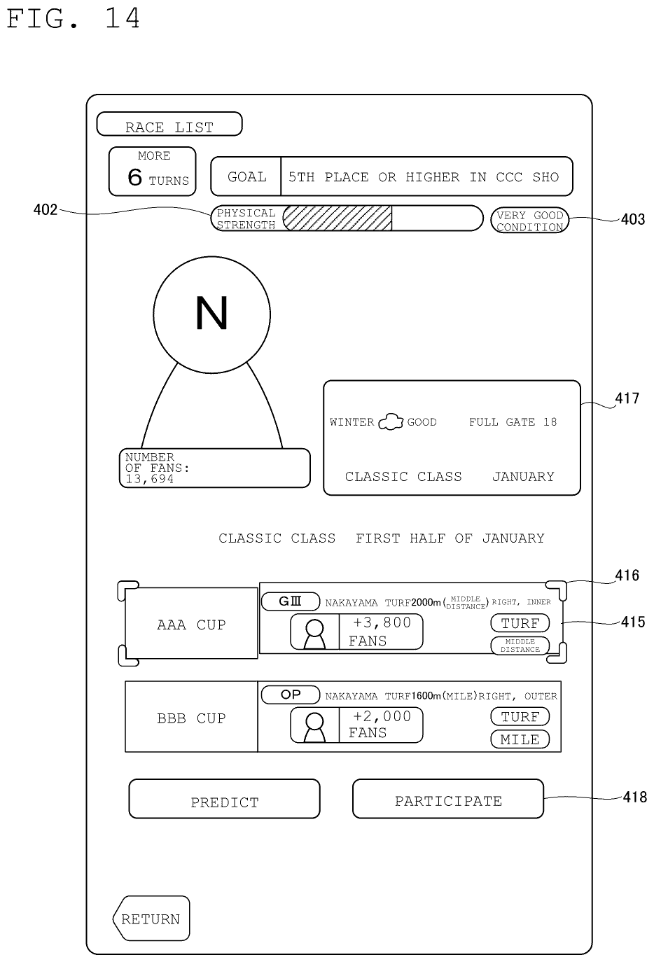

The race button 409 is a button used to make the character that is being nurtured participate in a race. When a tap input is performed with respect to the race button 409, the display screen is transitioned to a race list screen showing a list of races held in the current turn, as shown in FIG. 14.

In the race list screen, a race in which the character that is being nurtured is made to participate can be selected by performing a tap input with respect to a race selection box 415. The race that is being selected can be identified by the presence/absence of a selection mark 416. In a race condition display area 417, race condition information related to the race that is being selected, such as the season (spring, summer, fall, or winter), the weather (sunny, cloud, rain, or snow), the course condition (firm, good, yielding, or soft), the number of participating characters, and the turn of the race, is displayed. When the race that is being selected is changed, the display content of the race condition display area 417 is also changed in accordance with the race that is being selected. Furthermore, a participation condition is set for each race on the basis of the status of acquisition of the number of fans of the character that is being nurtured, and, for a race for which the character that is being nurtured does not satisfy the participation condition, the race selection box 415 is grayed out, whereby the character that is being nurtured is not allowed to participate in that race.

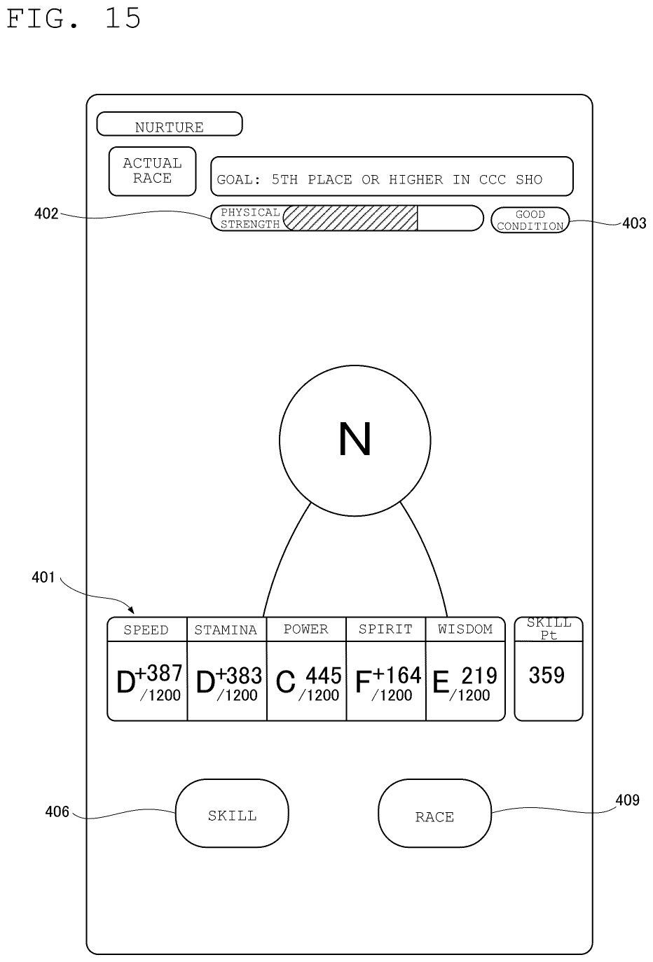

Furthermore, in this embodiment, there is a case in which a goal race is set as a nurture goal, the display mode of the nurture home screen is different in a turn in which a goal race is set, and only the skill button 406 and the race button 409 are displayed as buttons for selecting actions, as shown in FIG. 15. That is, in a turn in which a goal race is set, it is only possible to participate in the race as a turn consuming action.

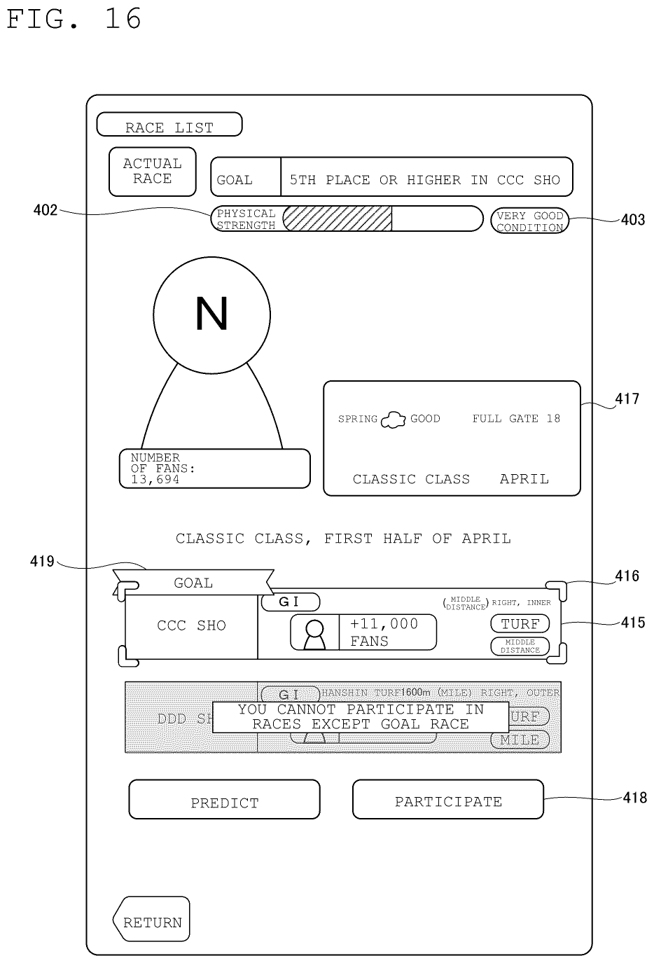

FIG. 16 is a view showing an example of a race list screen in a turn in which a goal race is set. In the case where a goal race is set as a nurture goal, control is performed such that only the goal race is selectable in the race list screen. In this embodiment, in the race list screen that includes a goal race, a goal badge 416 is attached to the race selection box 415 of the goal race, thereby making it possible to identify the goal race, and the race selection box 415 of a race other than the goal race is grayed out, whereby participation is not allowed.

When a tap input is performed with respect to a participation button 418 with the selection box 415 of the participation race being selected in the race list screen, a participation request is sent to the server 20. Upon reception of the participation request, the server 20 performs a running simulation using the character that is being nurtured and NPCs (non-player characters), for the participation-target race, and sends a race result response including the result of the running simulation to the player terminal 40. Upon reception of the race result response, the player terminal 40 executes display processing for showing the player the race based on the result of the running simulation.

In this embodiment, in the case where the character that is being nurtured is made to participate in a race, the performance parameters are adjusted in accordance with the stage of the motivation in the turn in which the participation is directed. In the case where the motivation is in the very bad condition or the bad condition, the performance parameters are corrected downward compared with the case in which the motivation is in the normal condition. In the case where the motivation is in the good condition or the very good condition, the performance parameters are corrected upward compared with the case in which the motivation is in the normal condition.

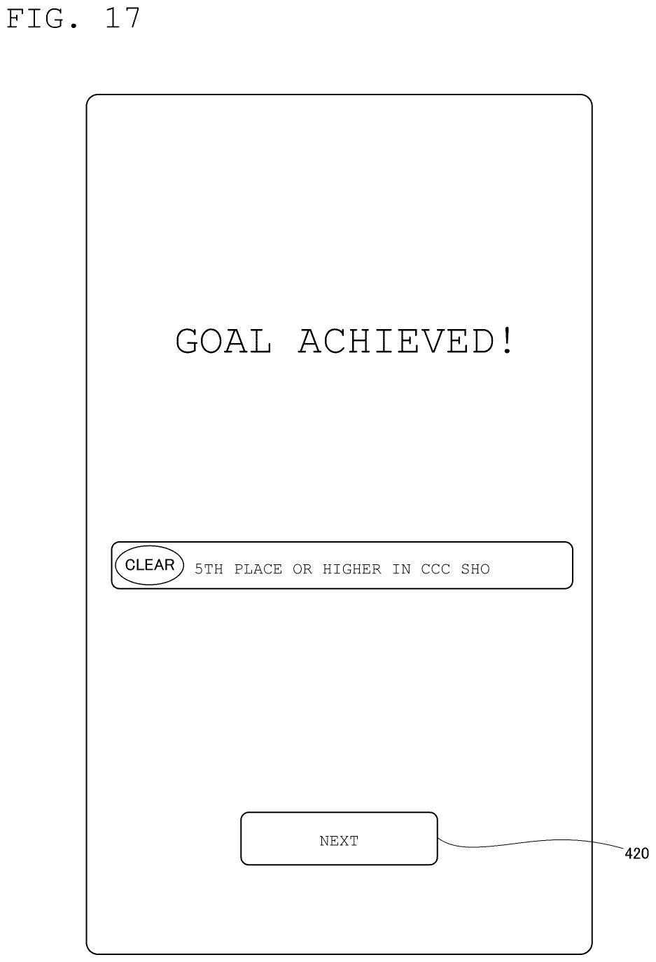

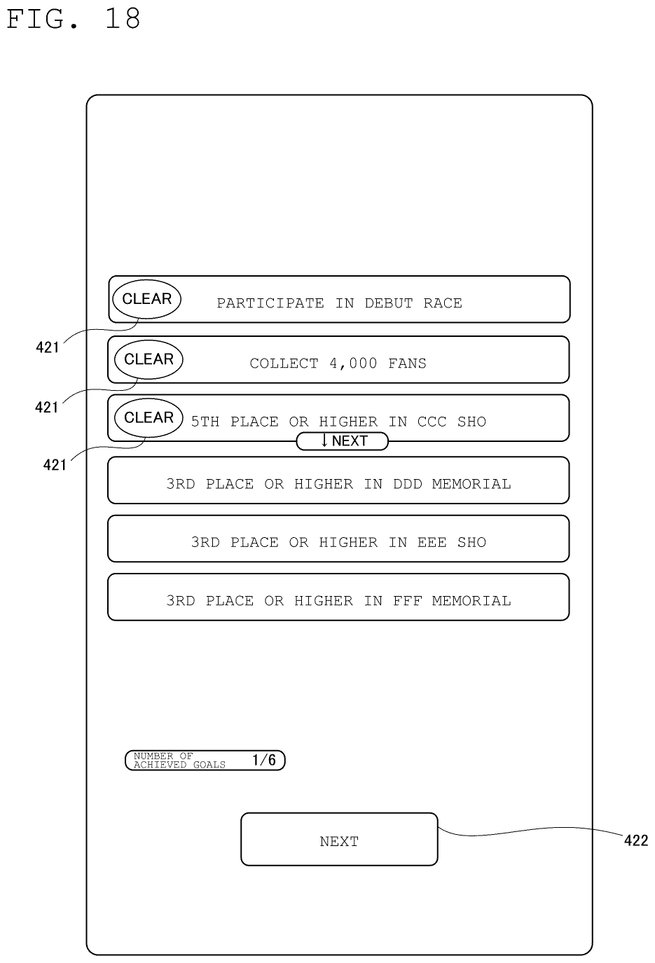

In a turn in which a nurture goal is set in the nurture of the character, it is determined whether the nurture goal has been achieved. In the case where the nurture goal has been achieved, a goal achievement notification screen is displayed, as shown in FIG. 17. In the example shown in FIG. 17, the nurture goal is to obtain the result of 5th place or higher in “CCC rize” that is a goal race, and, in the case where the character that is being nurtured has obtained the result of 5th place or higher in “CCC Sho”, the goal achievement notification screen is displayed after the result of the goal race is displayed. In the goal achievement notification screen, a progress button 420 is provided. When a tap input is performed with respect to the progress button 420, the display screen is transitioned to a goal list screen, as shown in FIG. 18.

In the goal list screen, a list of nurture goals set for the character that is being nurtured is displayed in the order of progress of turns. In the example shown in FIG. 18, six nurture goals are set for the character that is being nurtured, and a clear mark 421 indicating that the corresponding nurture goal has been achieved is attached to each of the nurture goals up to the third nurture goal “5th place or higher in CCC Sho”. In the goal list screen, a progress button 422 is provided, and, when a tap input is performed with respect to the progress button 422, the game progresses to the next turn, and the display screen returns to the nurture home screen.

In this embodiment, the nurture goals are set in the period until the 72nd turn, and the number of nurture goals and the content of nurture goals are individually set in accordance with the type of a character. Then, when the nurture goals set for the character that is being nurtured are all achieved, the game can progress to the last races in the 73rd and subsequent turns.

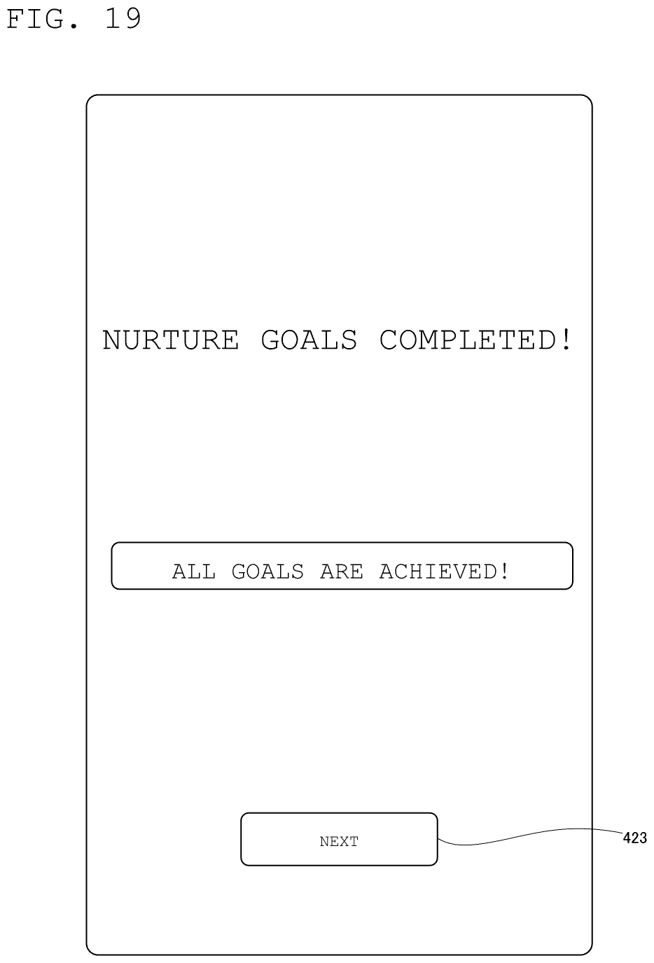

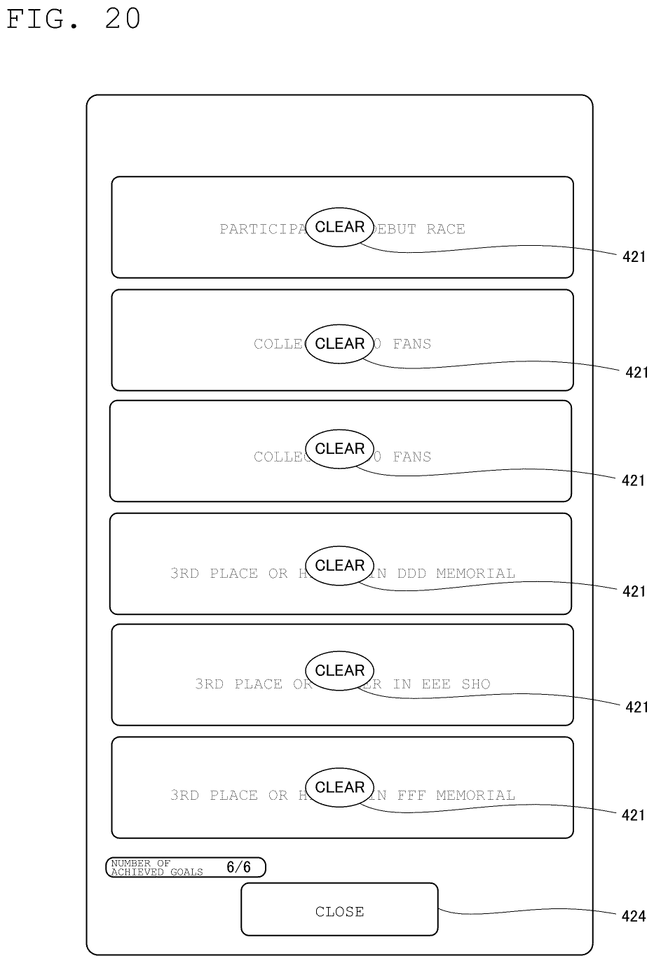

For example, when the last nurture goal set for the character that is being nurtured is achieved, the nurture-goal completion screen is displayed, as shown in FIG. 19. In the nurture-goal completion screen, a progress button 423 is provided, and, when a tap input is performed with respect to the progress button 423, the goal list screen is displayed, as shown in FIG. 20. In the goal list screen shown in FIG. 20, the clear mark 421 is attached to all of the six nurture goals set for the character that is being nurtured, whereby it can be understood that the nurture goals have all been achieved. Then, when a tap input is performed with respect to a close button 424 in the goal list screen, the game progresses to the next turn, and the display screen returns to the nurture home screen.

In the case where the nurture goals are all achieved in the nurture of the character, in the 73rd and subsequent turns, the character that is being nurtured is first made to participate in a qualifying race, is made to participate in a semi-final race when getting the result of 1 st place in the qualifying race, and is made to participate in a final race when getting the result of 1st place in the semi-final race. Then, the character that is being nurtured wins the last races when getting the result of 1st place in the final race, and the nurture ends. In the respective turns in which the qualifying race, the semi-final race, and the final race are held, it is also possible to give a direction of the nurture before participation. The last races in the 73rd and subsequent turns are held in extra turns in which no nurture goals are set. In the cases of the results other than 1st place in the qualifying race and the semi-final race, although it is possible to try again by using the continue function, the nurture ends if the number of continues is not left. Note that, since it is up to the player to use the continue function, as described earlier, in the case where the player selects not to use the continue function even if the continue function is available, the character that is being nurtured loses the last races, and the nurture ends.

Furthermore, in the case where the nurture goals set for the character that is being nurtured cannot be achieved, the nurture ends at this point. In particular, in this embodiment, in the case where a nurture goal is to get the result of a predetermined order of arrival or higher in a goal race, even when the result of the predetermined order of arrival or higher cannot be gotten in the goal race, it is possible to try again the goal race by using the continue function. However, in the case where a nurture goal is to obtain a predetermined number of fans by a predetermined turn, and in the case where a nurture goal is to participate in a goal race, it is impossible to use the continue function when the nurture goal cannot be achieved, and the nurture ends at the point in time when the turn for determining the nurture goal has come.

Then, when a nurture end condition is established in the nurture progression processing (Y in Step S106), end confirmation processing is performed (Step S107). In the end confirmation processing, an end confirmation screen in which the statuses of the nurture-target character can be confirmed is displayed. In the end confirmation screen, a skill acquisition button and a nurture end button are provided. When a tap input is performed with respect to the skill acquisition button, a list of obtainable skills is displayed, and it is possible to obtain a skill(s) within the range of the possessed skill points. When a tap input is performed with respect to the nurture end button, nurture end processing is performed (Step S108).

First, in the nurture end processing, registration of the nurtured character is performed. The registration of the nurtured character is completed when the statuses of the character are determined by calculating the evaluation points and determining the factor information and when the statuses are stored in the character list in the player data storage unit 71 while being linked to the character individual ID. The evaluation points are calculated on the basis of the performance parameters of the character and the obtained skills, and the factor information is determined by a lottery.

In particular, the factor information is determined by referring to the content of the nurture of the character (race participation history etc.) and the statuses (the performance parameters, obtained skills, etc.,) at the completion of the nurture. Furthermore, of the factor information, the blue factor and the red factor are always given, and the unique factor is given in the case where a talent blossoming level (level 1 to level 5) of the nurture-target character is a predetermined level or higher (level 3 or higher). Furthermore, fpr the white factor of the factor information, the skill factor is determined by referring to the obtained skills, the race factor is determined by referring to the race(s) in which the nurture-target character participates during the nurture and that the nurture-target character wins, and the scenario factor is determined by referring to the nurture scenario selected prior to the start of the nurture. Furthermore, in the case where the factor information is given, the factor level of the factor information determined to be given is determined by a lottery. In this embodiment, the factor level is randomly set to any of three stages from level 1 to level 3.

Furthermore, in the nurture end processing, rewards for the nurture result are also provided. In this embodiment, rewards are provided by being added to the item list in the player data storage unit 71. The in-game currency and the support points corresponding to the number of fans obtained during the nurture are determined as rewards, and more in-game currency and more support points can be obtained as the number of fans is increased.

Furthermore, in the nurture end processing, a nurture end request is sent to the server 20, and, when the nurture end request is received, the server 20 registers the nurtured character in the character list in the player management database 51 and adds the rewards for the nurture result to the item list in the player management database 51.

In this way, since this embodiment has a specification in which nurtured characters that have already been nurtured are used as inheritance characters to reinforce the statuses of a nurture-target character in the nurture of the character, the success or failure of the nurture is greatly affected by the determination made as to which nurtured characters are used as inheritance characters, in the preparatory stage of the nurture. However, at the stage of determining inheritance characters in the nurture function, it is not always that the player possesses nurtured characters that enable desired status reinforcement. Thus, in this embodiment, a representative character set by another player who is registered as a friend can be selected as an inheritance character.

Then, in this embodiment, in order to encourage information exchange between players, including the usage of friend registration, the name-card creation function is provided, which is capable of creating a player name card on which the profile information of a player is posted.

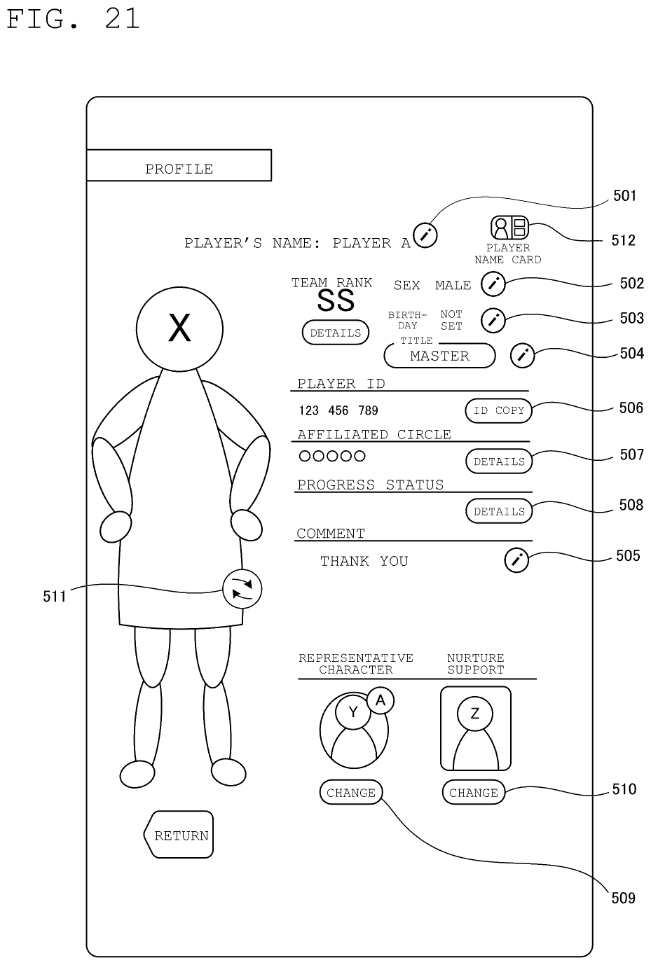

FIG. 21 is a view showing an example of a profile screen. In the profile screen, the player's name, the sex, the birthday, a title, a team rank, the player ID, an affiliated circle, a progress status, a comment, a representative character (representative character), a nurture support item (nurture support), a profile character, etc., are displayed. The player can arbitrarily edit predetermined items displayed in the profile screen. Regarding the player's name, the sex, the birthday, the title, and the comment, the display content can be changed by performing tap inputs with respect to edit buttons 501, 502, 503, 504, and 505 that are provided on the right of the corresponding items.

Furthermore, in the profile screen, an ID copy button 506 is provided. When a tap input is performed with respect to the ID copy button 506, text information of the player ID is copied to a clipboard of the player terminal 40, and the player ID can be input by performing a paste operation in another application.

Furthermore, in the profile screen, details buttons 507 and 508 are provided on the right of items of the affiliated circle and the progress status. When a tap input is performed with respect to any of the details buttons, details of the corresponding one of the affiliated circle and the progress status can be confirmed.

Furthermore, in this embodiment, the representative character (representative character), the nurture support item (nurture support), and the profile character can be set via the profile screen. For example, when a tap input is performed with respect to a change button 509, the screen is transitioned to a screen showing a list of possessed nurtured characters, and arbitrary one of the nurtured characters can be selected and set to a representative character. Furthermore, for example, when a tap input is performed with respect to a change button 510, the screen is transitioned to a screen showing a list of possessed support items, and arbitrary one of the support items can be selected and set to a nurture support item. Furthermore, for example, when a tap input is performed with respect to a change button 511, the screen is transitioned to a screen showing a list of released characters, and arbitrary one of the released characters can be selected and set to a profile character.

Then, in this embodiment, in the profile screen, a name-card creation button 512 is provided. When a tap input is performed with respect to the name-card creation button 512, the display screen is transitioned to a player name-card screen.

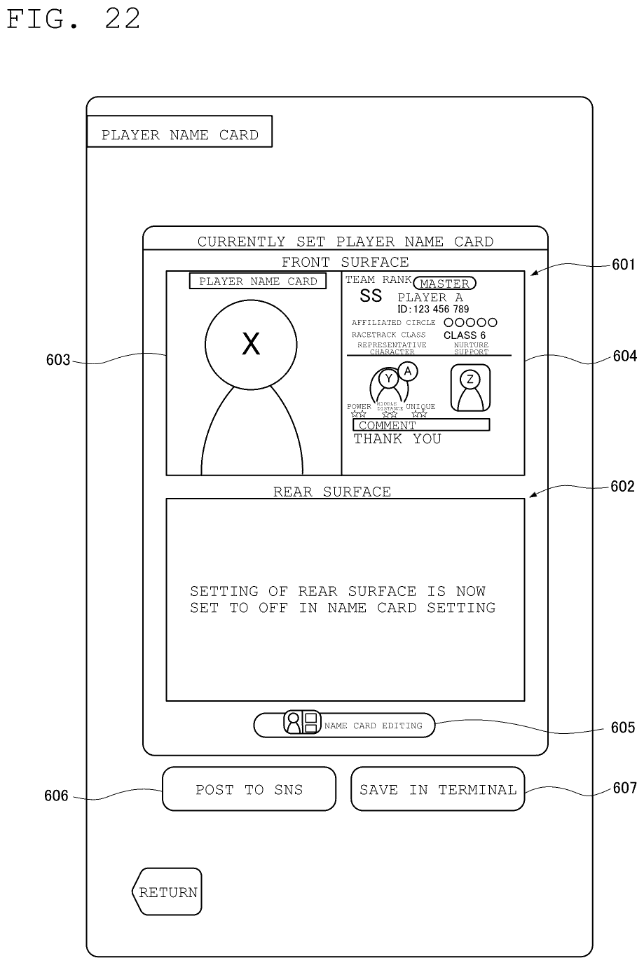

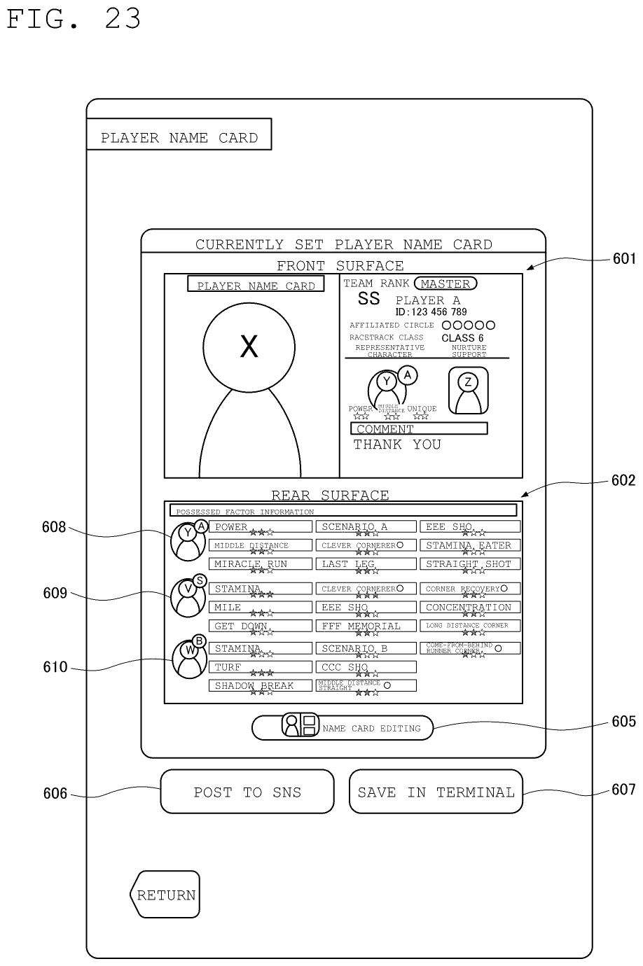

FIGS. 22 and 23 are views showing examples of the player name-card screen.

In this embodiment, it is possible to create a player name card consisting of only a front-surface image, as shown in FIG. 22, or a player name card consisting of a front-surface image and a rear-surface image, as shown in FIG. 23. Whether the rear-surface image is generated or not can be set by the player in a name-card edit screen to be described later.

As shown in FIGS. 22 and 23, in the player name-card screen, a first display area 601 in which the front-surface image is displayed and a second display area 602 in which the rear-surface image is displayed are provided. In the example shown in FIG. 22, since the display for the rear-surface image is set to OFF, the front-surface image is displayed in the first display area 601, whereas the rear-surface image is not displayed in the second display area 602. Furthermore, in the example shown in FIG. 23, since the display for the rear-surface image is set to ON, the front-surface image is displayed in the first display area 601, and the rear-surface image is displayed in the second display area 602. At the stage when a transition is made from the profile screen to the player name-card screen, the front-surface image and the rear-surface image are generated on the basis of the profile information set in the profile screen.

In the front-surface image, an illustration area 603 and a profile area 604 are provided. An image based on one of an image of a released character that is possessed by the player, an image of a support item that is possessed by the player, and a screenshot image acquired by using the photo function is displayed in the illustration area 603. In the initial settings, an image of a character determined in advance (for example, an initial character that is set to be possessed by all players from the start of the game) is set in the illustration area 603. Of the profile information of the player, the player's name, the player ID, the title, the team rank, the affiliated circle, a race field rank, the representative character (representative character), the nurture support item (nurture support), and the comment are displayed in the profile area 604. In the initial settings, the title and the comment are set to a title and a comment that are determined in advance (for example, an initial title possessed by all players from the start of the game and a fixed comment), and, regarding the other items, the corresponding kinds of information set in the profile screen are set in the profile area 604. Then, in this embodiment, in the front-surface image, the factor information of the representative character is simply displayed below the icon indicating the representative character. Specifically, the blue factor, the red factor, and the unique factor (only if the unique factor is set) of the representative character are displayed together with the factor level (the number of stars). In the example shown in FIG. 22, the factor information of the representative character can be grasped as follows: the blue factor indicates power of factor level 2, the red factor indicates middle distance of factor level 2, and the unique factor is related to a character Y and indicates factor level 2.

In the rear-surface image, the factor information related to a representative character 608 and two inheritance characters 609 and 610 used for nurture of the representative character 608 is specifically displayed. In the rear-surface image, the factor information linked to the individual characters is displayed in order of the representative character 608, the first inheritance character 609, and the second inheritance character 610 from the top, as shown in FIG. 23 (see FIG. 6 for the first inheritance character and the second inheritance character). In this embodiment, up to nine pieces of factor information can be displayed for each character. Note that pieces of factor information to be displayed in the rear-surface image are sorted according to the display priority order based on the kinds of the factor information. Furthermore, in the case where ten or more pieces of factor information are linked to one character, the top nine pieces of factor information based on the display priority order are displayed. Determination of pieces of factor information to be displayed in the rear-surface image and the order of display of the pieces of the factor information will be described in detail later.

Furthermore, in the player name-card screen, a name-card edit button 605 is provided. When a tap input is performed with respect to the name-card edit button 605, the display screen is transitioned to the name-card edit screen. Furthermore, in the player name-card screen, an SNS post button 606 is provided. When a tap input is performed with respect to the SNS post button 606, the image of the player name card displayed in the player name-card screen is posted on the social networking service (SNS), together with a fixed text. Furthermore, in the player name-card screen, a terminal save button 607 is provided. When a tap input is performed with respect to the terminal save button 607, the image of the player name card displayed in the player name-card screen is saved in an image storage area (for example, a photo folder or the like) in the storage unit 42 of the player terminal 40 in a well-known data format (for example, JPEG format).

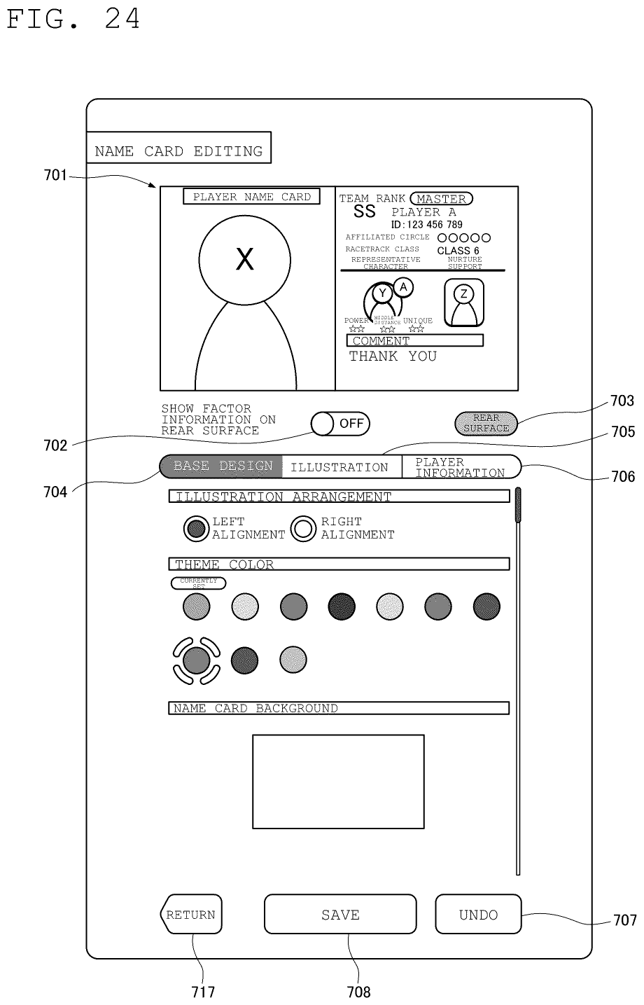

FIGS. 24 to 27 are views showing examples of the name-card edit screen. In this embodiment, of the display content of the player name card, a base design, an illustration, and player information can be edited via the name-card edit screen.

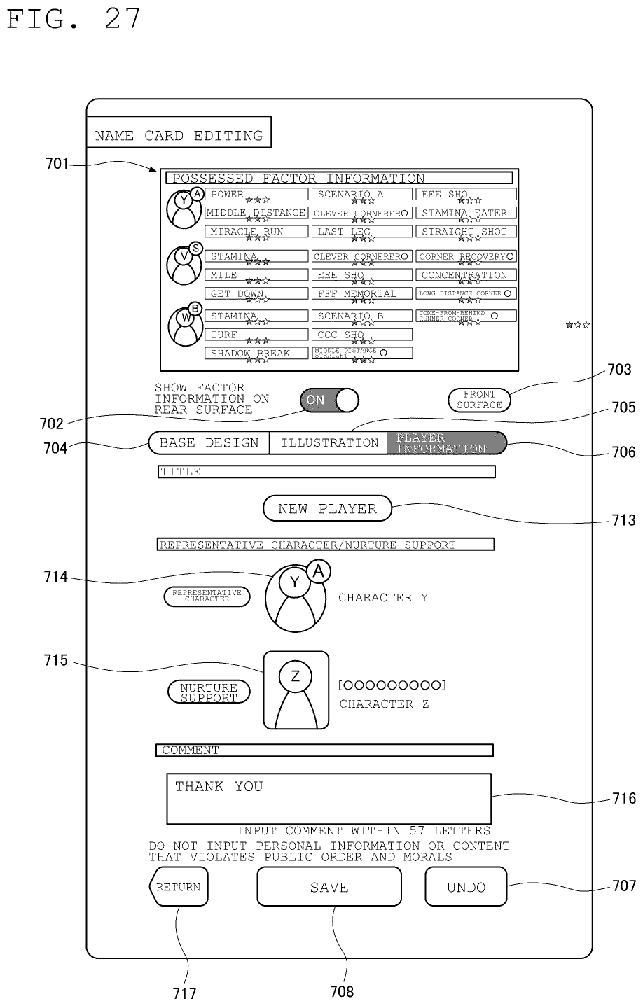

In the name-card edit screen, an image display area 701 is provided, and either the front-surface image or the rear-surface image can be displayed in the image display area 701. Note that, when the display of the rear-surface image is set to ON by means of a rear-surface permission button 702, an input with respect to an image switch button 703 is enabled, and the image to be displayed in the image display area 701 can be switched between the front-surface image and the rear-surface image. As shown in FIGS. 24 to 26, in the case where the display of the rear-surface image is set to OFF in the rear-surface permission button 702, the image switch button 703 is disabled, and switching to the rear-surface image cannot be performed. With the image switch button 703 being disabled, the image switch button 703 is grayed out. On the other hand, as shown in FIG. 27, in the case where the display of the rear-surface image is set to ON in the rear-surface permission button 702, a tap input with respect to the image switch button 703 can be accepted. When a tap input is performed with respect to the image switch button 703 with the front-surface image being displayed in the image display area 701, the rear-surface image is displayed in the image display area 701.

In the name-card edit screen, which of the base design, the illustration, and the player information is to be edited can be switched by using a base design tab 704, an illustration tab 705, and a player information tab 706.

In the name-card edit screen, for example, when a tap input is performed with respect to the base design tab 704, items of illustration arrangement, a theme color, and a name-card background can be edited, as shown in FIG. 24.

Regarding the illustration arrangement, the arrangement of an illustration area can be set as to whether the illustration area is aligned to left or right. Although the illustration area is aligned to left in the example shown in FIG. 24, if the illustration area is aligned to right, the position of the illustration area and the position of a profile area are switched.

Regarding the theme color, the color of the border of the image of the player name card can be set. In this embodiment, color icons of 10 kinds of theme colors are prepared, and the theme color can be changed by tapping any of the color icons. Note that a badge icon in which a text of “currently set” is written is attached to the currently set theme color.

Regarding the name-card background, background patterns for the front-surface image and the rear-surface image can be set. In this embodiment, when a tap input is performed on a display area of a background pattern in the item of the name-card background, a dialog box for selecting a background pattern is displayed, and the name-card background can be set from among five kinds of background patterns including “no background”.

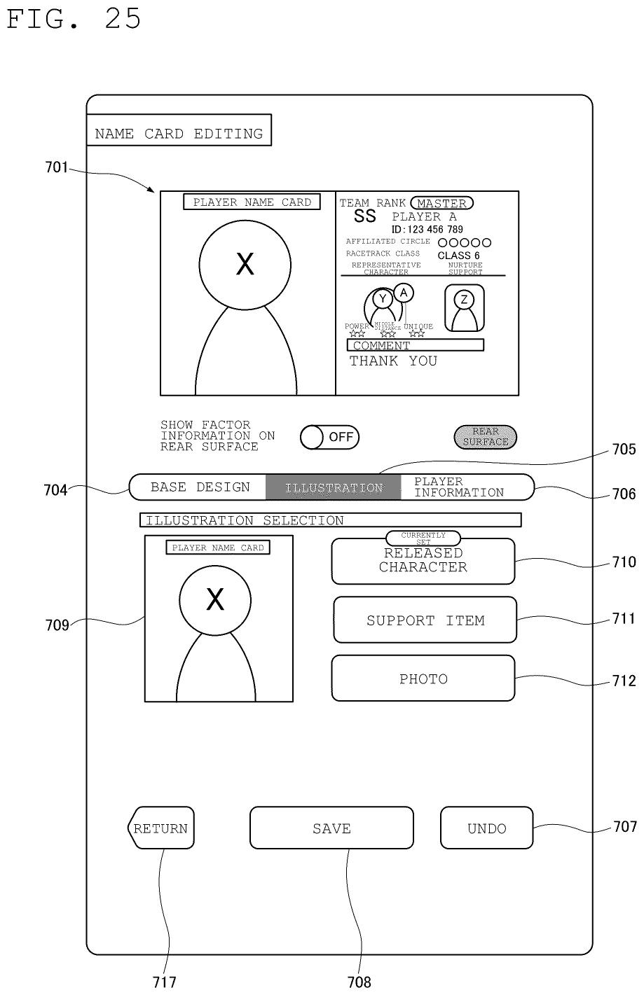

Furthermore, for example, when a tap input is performed with respect to the illustration tab 705 in the name-card edit screen, an image to be displayed in the illustration area can be edited, as shown in FIG. 25. A confirmation area 709 in which an image for the illustration area is displayed is set below an item of illustration selection, and the edited content can be confirmed in the confirmation area 709. An image to be displayed in the illustration area can be set from an image of a released character that is possessed by the player, an image of a support item that is possessed by the player, or a screenshot image acquired by using the photo function.

In the case where an image of a released character is to be set, a tap input is performed with respect to a released-character button 710, to display a dialog box that shows a list of released characters possessed by the player, thus allowing arbitrary one released character to be selected. Furthermore, in the case where an image of a released character is set, it is also possible to set a costume of the character and a background thereof. As the steps for the settings, selection of a character, selection of a costume, and selection of a background are performed in this order.

Furthermore, in the case where an image of a support item is to be set, a tap input is performed with respect to a support item button 711, to display a dialog box that shows a list of support items possessed by the player, thus allowing an arbitrary item to be selected. Furthermore, in the case where an image of a support item is set, a section thereof to be displayed can be adjusted by enlarging, reducing, rotating, or moving the image.

Furthermore, in the case where a screenshot image acquired by using the photo function is to be set, a tap input is performed with respect to a photo button 712, to display a dialog box that shows a list of screenshot images stored in the image data storage unit 76, thus allowing an arbitrary one screenshot image to be selected. Furthermore, in the case where a screenshot image is set, a section thereof to be displayed can also be adjusted by enlarging, reducing, rotating, or moving the image. Furthermore, in the case where a screenshot image acquired by using the photo function is determined as an illustration to be used in the front-surface image of the player name card, the used screenshot image is sent to the server 20 each time, and is backup saved as an image linked to the player name card.

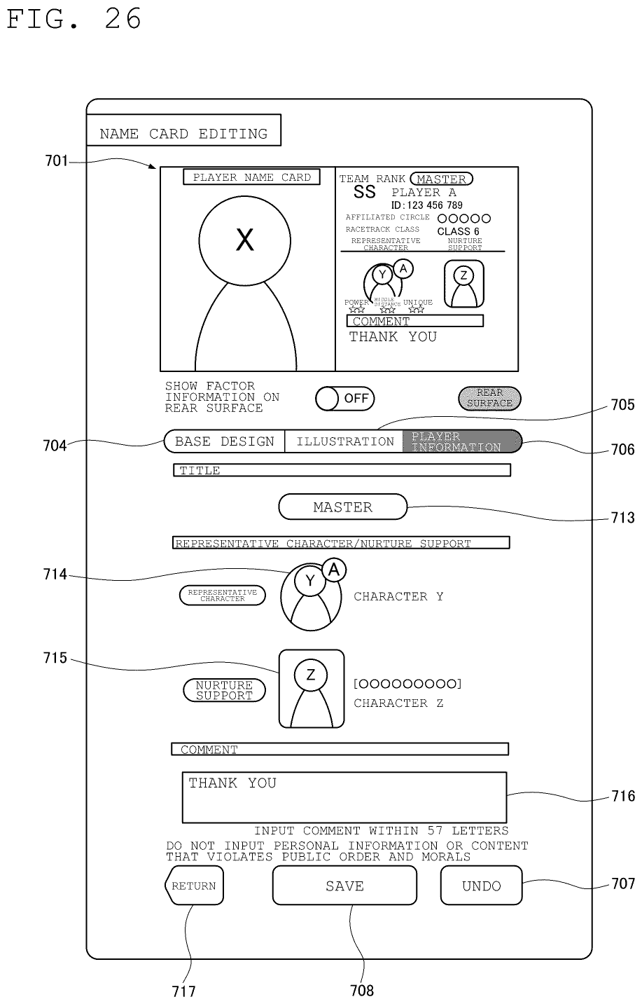

Furthermore, for example, when a tap input is performed with respect to the player information tab 706 in the name-card edit screen, the title, the representative character (representative character), the nurture support item (nurture support), and the comment can be edited, as shown in FIG. 26 or 27.

In the case where the title is edited, a tap input is performed with respect to a title icon 713 that indicates the currently set title, to display a dialog box that shows a list of titles possessed by the player, thus allowing an arbitrary title to be selected.

In the case where the representative character is edited, a tap input is performed with respect to a representative-character icon 714 that indicates the currently set representative character, to display a dialog box that shows a list of nurtured characters possessed by the player, thus allowing an arbitrary one nurtured character to be selected. In this embodiment, in the case where the representative character has been changed via the name-card edit screen, the representative character set in the profile screen is also changed accordingly.

In the case where the nurture support item is edited, a tap input is performed with respect to a nurture support icon 715 that indicates the currently set nurture support item, to display a dialog box that shows a list of support items possessed by the player, thus allowing an arbitrary item to be selected. In this embodiment, in the case where the nurture support item has been changed via the name-card edit screen, the nurture support item set in the profile screen is also changed accordingly.

In the case where the comment is edited, a tap input is performed with respect to a comment edit field 716, thus allowing a text input. Note that, in this embodiment, there is a limit on the number of letters to be input as a comment, an input of a text with letters more than 57 letters is disabled. Furthermore, forbidden words that are not suitable for publication are set, and, in the case where a forbidden word is input in the comment edit field 716, an error message is displayed when the input content is to be saved, and reflection of the edited content is restricted.

Furthermore, in the case where the edited content of each of the items is to be discarded in the name-card edit screen, a tap input is performed with respect to an “undo” button 707, thereby making it possible to discard the edited content. Furthermore, in the case where each of the items is being edited via the name-card edit screen, a tap input is performed with respect to a save button 708, whereby the front-surface image and the rear-surface image in which the edited content has been reflected are generated and displayed in the image display area 701. Furthermore, in the case where editing of the player name card via the name-card edit screen is to be finished, a tap input is performed with respect to a return button 717, whereby the screen returns to the player name-card screen.

In this way, in this embodiment, the front-surface image on which the factor information linked to the representative character, selected as a post target for the player name card, is simply displayed and the rear-surface image on which the factor information of the representative character is specifically displayed are generated, thereby making it possible to give the player a room for selection of an image of a suitable amount of information for the usage and to improve convenience regarding information exchange between players.

Furthermore, in this embodiment, since the front-surface image and the rear-surface image are generated such that the player ID, which is the identification information of the player, is displayed on the front-surface image and is not displayed on the rear-surface image, it is possible to give consideration to a player who does not desire the personal information to be identified and to encourage active information exchange between players. However, the player ID may be displayed not only on the front-surface image but also on the rear-surface image. By doing so, it is possible to prevent impersonation from being done by plagiarizing an image on a player name card of another player posted on a social networking service (SNS). Furthermore, it is also possible that personally identifiable information such as the player's name, the player ID, and the affiliated circle displayed in the profile area on the front-surface image can be hidden in the option settings.

Furthermore, in this embodiment, although the factor information related to the representative character and the two inheritance characters of the representative character is displayed on the rear-surface image, since the number of pieces of factor information of each character that can be displayed is limited (up to 9), a technique for determining display targets by providing the display priority order is adopted.

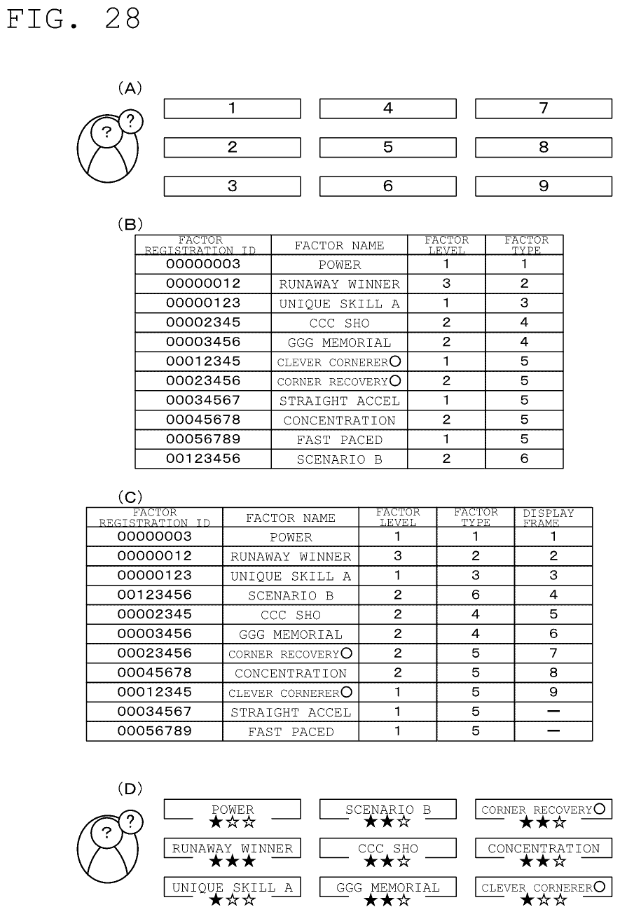

FIG. 28 is a view for explaining a technique for determining the relationships between display targets of factor information and display frames, related to the rear-surface image.

First, as shown in FIG. 28(A), for a character posted on the rear-surface image, nine display frames for pieces of factor information linked to the character are provided. Frame numbers 1 to 9 are made to correspond to the display frames. On the basis of the result of sorting the pieces of factor information linked to the character according to the display priority order, the pieces of factor information and the display frames are made to correspond to each other, whereby the pieces of factor information to be displayed in the display frames are determined.

FIG. 28(B) is a view showing details of factor information linked to a certain character (a representative character or an inheritance character). The factor information includes the factor registration ID, the factor name, the factor level, and the factor type. The factor information is sorted in ascending order of the factor type thereof, and, with the same factor type, the factor information is sorted in ascending order of the factor registration ID thereof. In the case where the player refers to the factor information from the list of nurtured characters, the factor information linked to the character can be browsed in the sort order shown in FIG. 28(B). By the factor type, the factor information is classified into the blue factor, the red factor, the unique factor, the race factor, the skill factor, and the scenario factor. The factor type “1” indicates the blue factor, the factor type “2” indicates the red factor, the factor type “3” indicates the unique factor, the factor type “4” indicates the race factor, the factor type “5” indicates the skill factor, and the factor type “6” indicates the scenario factor.

In this embodiment, in the case where the factor information linked to the character is posted on the rear-surface image of the player name card, the factor information is sorted according to the special display priority order. Specifically, the factor information is sorted according to the display priority order, i.e., in the order of the factor types of 1>2>3>6>4=5, in descending order of the factor level for the race factor and the skill factor, and in ascending order of the factor registration ID for the race factor and the skill factor having the same factor level. That is, in this embodiment, the display priority order is set such that the scenario factor, which is the lowest in a usual sort order, is set in a higher order than the race factor and the skill factor, and the race factor and the skill factor are set in higher orders as the factor levels are higher. Furthermore, the number of display frames for the race factor and the skill factor is obtained by subtracting the number of pieces of factor information to be displayed, among the factor types of 1, 2, 3, and 6, from the maximum number of display frames. In the example shown in FIG. 28(B), since one blue factor, one red factor, one unique factor, and one scenario factor are present, the maximum number of display frames (nine)—the number of display frames (four) for the factor types of 1, 2, 3, 6=the number of display frames (five) for the race factor and the skill factor. There are cases in which no unique factor is present and in which no scenario factor is present depending on a character, and, in such cases, the number of display frames for the race factor and the skill factor is increased. Note that it is also possible that the display frames for the blue factor, the red factor, and the unique factor are fixed, and, in the case where there is no corresponding factor information, the display frames for those pieces of factor information are displayed in blank.

The result of the sorting performed according to the display priority order of this embodiment is as shown in FIG. 28(C). Specifically, nine pieces of factor information from the top of the display priority order for the rear-surface image become display targets for the rear-surface image and are made to correspond to the display frames. When the display-target pieces of factor information have been made to correspond to the display frames in this way, it is possible to generate the rear-surface image in which the factor names and the factor levels are displayed in the display frames, as shown in FIG. 28(D).

In this way, in this embodiment, pieces of factor information to be displayed on the rear-surface image are determined according to the display priority order, which is based on the kinds of factor information linked to the representative character and the inheritance characters, and the race factor and the skill factor are displayed preferentially from those of higher factor levels, while the scenario factor, which expects significant increases in performance parameters in a factor inheritance event, is preferentially displayed; thus, it is possible to encourage useful information exchange between players.

Note that, in the case where ten or more pieces of factor information are linked to one character, as in the example shown in FIG. 28, it is also possible to display a text “n pieces of other factor information” so as to indicate the number of pieces of factor information that are not displayed on the rear-surface image. By doing so, at least the number of pieces of factor information linked to each character can be grasped, and appropriate information can be posted in a small space.

Furthermore, instead of sorting all pieces of factor information linked to one character as in this embodiment, it is also possible that display frames are determined in the order of the blue factor, the red factor, the unique factor, and the scenario factor according to the display priority order, prior to the race factor and the skill factor, and, pieces of factor information to be filled in the remaining number of display frames for display targets of the race factor and the skill factor are extracted on the basis of the factor level and the factor registration ID.

Furthermore, it is also possible that the player can arbitrarily set pieces of factor information that become display targets for the rear-surface image. Note that, in the case where the player is made to set display-target factor information, specific pieces of factor information, such as the blue factor, the red factor, and the unique factor, are definitely displayed, and only the white factor can be arbitrarily set as a display target(s) by the player. That is, although the player can individually set factor information to be displayed on the rear-surface image, fixed display frames and free display frames are provided as display frames for the factor information on the rear-surface image, and the player may be able to custom only the free display frames.

Furthermore, in this embodiment, although pieces of factor information are classified by the factor type, and the display priority order based on the factor type is set, it is also possible to set the display priority order individually for pieces of factor information. Furthermore, the factor information may also be classified by the status reinforcement effect exerted in a factor inheritance event, and, for example, the display priority order may be set by classifying the factor information into factor information having a performance-parameter increase effect and factor information having a skill-acquisition-level increase effect. Furthermore, for the skill factor, the display priority order may be set on the basis of classification based on skill effects; for example, the display priority order may be different depending on effects of skills, such as a speed increase skill, an acceleration increase skill, a restoration skill, and a debuff skill. That is, as the classification criteria for setting the display priority order of factor information, characteristics and attributes of the factor information can be used.

Furthermore, in this embodiment, there is a function of acquiring, saving, and browsing screenshot images of game screens by using the photo function. The photo function can be used when an item “display an image acquisition button” in the photo function in the settings of the input interface is set to ON.

In this embodiment, the photo function is available while a race video for showing a race of characters is being played in the race match function and while a live video for showing live singing of a character is being played in the live viewing function. Note that, in the case where there is a story mode in which a story video is to be played and enjoyed, the photo function may also be available in the story mode.

In this embodiment, when the image acquisition button is displayed on the display screen, such as a race-video playback screen, a live-video playback screen, etc., in which the photo function is available and when a tap input is performed with respect to the image acquisition button, a screenshot image at the time when the input is accepted is acquired, and the display screen is transitioned to a screenshot image save screen. When the player determines to save the screenshot image in the save screen, the acquired image is saved in the image data storage unit 76. Note that playback of the race video or the live video is paused at the time when the tap input with respect to the image acquisition button is accepted, and, when the display screen is returned from the save screen, the pause is released, whereby playback of the race video or the live video is resumed.

In the save screen, not only saving of a screenshot image but also filtering can be performed, and a screenshot image can be subjected to filtering, by using a known technique, such as tonal correction (change to sepia tone or change to monochrome). Furthermore, in this embodiment, user interfaces (UI) such as various kinds of buttons are displayed in a race video or a live video, and display of UI or non-display of UI can be selected in the save screen. Note that, when a screenshot image is to be acquired by using the photo function, two screenshot images for display of UI and non-display of UI are acquired in a work buffer, and one of the screenshot images selected by the player is saved in the image data storage unit 76. An upper limit number of saved images is set in the image data storage unit 76, and, in the case where a screenshot image is to be saved beyond the upper limit number of saved images, the screenshot image is saved by overwriting a screenshot image of which save date and time are old and that is not in a locked state. Furthermore, in the case where a screenshot image is subjected to filtering and is saved, two images, i.e., the original image and the filtered image, are saved in the image data storage unit 76.

Screenshot images saved in the image data storage unit 76 can be browsed from a photolibrary. In the photolibrary, a favorite screenshot image can be set in a locked state, thereby being prevented from being overwritten. An upper limit is set on the number of images that can be set in the locked state, and when the upper limit is reached, a screenshot image cannot be newly set in the locked state as long as at least one screenshot image that has already been set in the locked state is released. In the photolibrary, a screenshot image stored in the image data storage unit 76 can also be deleted.

Furthermore, in this embodiment, although a description has been given of an example of the game in which two of the nurtured characters can be set as inheritance characters when a character is nurtured, the number of nurtured characters to be selected as an inheritance character(s) needs to be at least one, and it is also possible to set a specification in which three or more inheritance characters can be set. Furthermore, the present invention may have a configuration in which the functions of the information processing system 10 are provided in other games. For example, the present invention can be applied to sports games, such as baseball games and soccer games, in which a character that is made to participate in a competition is nurtured, and a nurtured character(s) can be used to reinforce the statuses of the nurture-target character. Furthermore, the present invention can be applied to games of other genres, such as card battle games, fighting games, action games, battle royale games, roll playing games, etc., in which a character is nurtured, and a nurtured character(s) can be used to reinforce the statuses of the nurture-target character.

1. A program for a game in which, on the basis of specific information linked to a character possessed by a player, the ability of another character is affected in the game progress using said another character, the program causing a computer to function as:
a character selection accepting unit that accepts selection of the character serving as a post target from the character possessed by the player; and
an image generating unit that generates, on the basis of the specific information linked to the character selected as the post target, a first image on which the specific information is simply displayed and a second image on which the specific information is specifically displayed.

2. A program according to claim 1, wherein, according to a display priority order based on the kinds of the specific information linked to the character selected as the post target, the image generating unit determines the specific information to be displayed on the second image.

3. A program according to claim 1, wherein the image generating unit generates the first image and the second image such that identification information of the player is displayed on one of the first image and the second image and is not displayed on the other.

4. An information processing system for a game in which, on the basis of specific information linked to a character possessed by a player, the ability of another character is affected in the game progress using said another character, the information processing system comprising:
a character selection accepting unit that accepts selection of the character serving as a post target from the character possessed by the player; and
an image generating unit that generates, on the basis of the specific information linked to the character selected as the post target, a first image on which the specific information is simply displayed and a second image on which the specific information is specifically displayed.

5. An information processing method for a game in which, on the basis of specific information linked to a character possessed by a player, the ability of another character is affected in the game progress using said another character, the information processing method comprising:
a character selection accepting step for accepting selection of the character serving as a post target from the character possessed by the player; and
an image generating step for generating, on the basis of the specific information linked to the character selected as the post target, a first image on which the specific information is simply displayed and a second image on which the specific information is specifically displayed.
